(19) United States
(12) Patent Application Publication
(10) Pub. No.: US 2024/0175809 A1
(43) Pub. Date: May 30, 2024

(54) SYSTEM AND COMPUTER-IMPLEMENTED METHOD FOR DETERMINING PREDICTED COMPONENT CONCENTRATIONS OF A TARGET MIXTURE

(71) Applicant: National University of Singapore, Singapore (SG)

(72) Inventors: Jingkai Zhou, Singapore (SG); Zixuan Zhang, Singapore (SG); Zhihao Ren, Singapore (SG); Chengkuo Lee, Singapore (SG)

(21) Appl. No.: 18/396,410

(22) Filed: Dec. 26, 2023

(30) Foreign Application Priority Data
Feb. 15, 2023 (SG) 10202300375Q
Dec. 21, 2023 (SG) 10202303588S

(51) Int. Cl. G01N 21/35; G06F 18/2415

(52) U.S. Cl. CPC G01N 21/35; G06F 18/2415

(57) ABSTRACT

A system 300 for determining predicted component concentrations of a target mixture is described in an embodiment. The system 300 comprises a mid-infrared waveguide sensor 302 configured to measure absorption spectra and a computer 304. The computer 304 comprises a processor 402 and a data storage 414 storing computer program instructions operable to cause the processor to: (i) receive first training absorption spectra for a plurality of training mixtures from the mid-infrared waveguide sensor 402, the plurality of training mixtures each having one or more components associated with the target mixture and comprises different predetermined component concentrations; (ii) train a first machine learning model using the first training absorption spectra to obtain a first trained machine learning model, the first trained machine learning model being adapted to classify an absorption spectrum of a mixture having one or more of the components associated with the target mixture to identify specific component concentrations of the mixture, the identified specific component concentrations being one of the different predetermined component concentrations; (iii) receive, from the mid-infrared waveguide sensor 302, a target absorption spectrum of the target mixture; and (iv) determine the predicted component concentrations of the target mixture by classifying the target absorption spectrum using the first trained machine learning model. A method 500 for determining predicted component concentrations of a target mixture is also described.

### RELATED APPLICATIONS

This application claims priority under 35 U.S.C. § 119 or 365 to Singapore Application Nos. SG 10202300375Q, filed on Feb. 15, 2023, and 10202303588S, filed on Dec. 21, 2023, the entire teachings of which are incorporated herein by reference.

### TECHNICAL FIELD

The present disclosure relates to a system and a computer-implemented method for determining predicted component concentrations of a target mixture.

### BACKGROUND

Over the years, chem/biosensors have grown rapidly along with a variety of sensing mechanisms being developed, such as electrochemistry sensors, mechanical sensors, and optical sensors. Among these, nanophotonic waveguides provide a cost-effective solution for miniaturized sensor applications due to the high compactness and versatility from the increasing levels of integration, which also benefits other photonic devices, such as the nanophotonic waveguide-based spectrometer.

Near-infrared (NIR) waveguide sensing has become the mainstream development of on-chip optical sensing applications due to its mature technical platform. Most of the NIR waveguide sensors utilize a change in a refractive index (RI) induced by an appearance of an analyte for sensing analysis, as the change of RI causes a shift of a resonant (or interference) peak as measured by the NIR waveguide sensor. However, the ability of specific analyte detection for the NIR waveguide sensor without using specific receptors is lacking.

Recently, nanoantennae operating in the mid-infrared (MIR) wavelength range for on-chip chem/biosensing has been explored. The MIR spectroscopy sensing is attractive because there are numerous absorption fingerprints of molecules/chemical bonds in the MIR range. Together with sensitivity enhancement, such as surface-enhanced infrared absorption, provided by the nanoantennae, different analytes can be detected directly using an intensity change at a particular wavelength of an absorption spectrum, thereby enabling label-free and non-destructive molecular sensing for fluid or gas monitoring. Therefore, as miniaturized solutions, MIR waveguide sensors are promising for compositional detection of molecular mixtures leveraging absorption signatures, as compared with the near-infrared waveguide sensor that relies on resonant peak shift that lacks specificity.

Despite this superiority, the scheme for a fully integrated nanoantenna sensing system implemented on a single chip is still absent. Further, quantitative analysis of complex liquid mixture components in the MIR remains challenging, as the superposition of absorption from multiple substances may affect the absorbance at the absorption peak of interest, not to mention the presence of a typically strong water absorption background which can mask the absorption peak. Attempts had been made to use heavy water (D₂O) to replace water (H₂O) in a mixture to evade the intrinsic strong water absorption but a water environment is ubiquitous and therefore contributes to the crucial sensing background of an absorption spectrum that cannot be avoided.

It is therefore desirable to provide a system and a computer-implemented method for determining predicted component concentrations of a target mixture, which address the aforementioned problems and/or provides a useful alternative. Further, other desirable features and characteristics will become apparent from the subsequent detailed description and the appended claims, taken in conjunction with the accompanying drawings and this background of the disclosure.

### SUMMARY

Aspects of the present application relate to a system and a computer-implemented method for determining predicted component concentrations of a target mixture.

In accordance with a first aspect, there is provided a system for determining predicted component concentrations of a target mixture. The system comprising: a mid-infrared waveguide sensor configured to measure absorption spectra; and a computer comprising a processor and a data storage storing computer program instructions operable to cause the processor to: receive, from the mid-infrared waveguide sensor, first training absorption spectra for a plurality of training mixtures, the plurality of training mixtures each having one or more components associated with the target mixture and comprises different predetermined component concentrations; train a first machine learning model using the first training absorption spectra to obtain a first trained machine learning model, the first trained machine learning model being adapted to classify an absorption spectrum of a mixture having one or more of the components associated with the target mixture to identify specific component concentrations of the mixture, the identified specific component concentrations being one of the different predetermined component concentrations; receive, from the mid-infrared waveguide sensor, a target absorption spectrum of the target mixture; and determine the predicted component concentrations of the target mixture by classifying the target absorption spectrum using the first trained machine learning model.

By training a first machine learning model using training absorption spectra to obtain a first trained machine learning model adapted to classify an absorption spectrum of a mixture having one or more of the components associated with the target mixture, predicted component concentrations of a target mixture can be determined by classifying the target absorption spectrum using the first trained machine learning model. The first trained machine learning model is adapted to identify specific component concentrations using an absorption spectrum by classifying the absorption spectrum into one of the predetermined component concentrations used for training the first machine learning model. This provides an efficient and rapid way to identify and predict component concentrations in a target mixture using a target absorption spectrum of the target mixture.

The data storage of the computer may store computer program instructions operable to cause the processor to: receive, from the mid-infrared waveguide sensor, second training absorption spectra for the plurality of training mixtures; train a second machine learning model using the second training absorption spectra to obtain a second trained machine learning model, the second trained machine learning model being adapted to decompose the absorption spectrum of the mixture into component absorption spectra associated with components of the mixture; and decompose the target absorption spectrum into target component absorption spectra using the second trained machine learning model, each of the target component absorption spectra being associated with a corresponding component of the target mixture and comprises a predetermined number of data points across measured wavelengths of the target absorption spectrum. Decomposing the target absorption spectrum into its component absorption spectra allow further analysis to be performed on these target component absorption spectra.

The data storage of the computer may store computer program instructions operable to cause the processor to: receive, from the mid-infrared waveguide sensor, measured absorption spectra of each of the components of the target mixture, the measured absorption spectra of each of the components include a series of measured absorption spectra of varying concentrations of a respective component; apply linear fitting to the measured absorption spectra of each of the components to determine predetermined wavelengths of the measured absorption spectra for comparison; and compare each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths. This provides a way to obtain predicted component concentration using the target component absorption spectra.

Where the predicted component concentration for each of the components of the target mixture may include a plurality of predicted component concentrations, each of the plurality of the predicted component concentrations being associated with a corresponding one of the predetermined wavelengths, the data storage of the computer may store computer program instructions operable to cause the processor to: average the plurality of predicted component concentrations to obtain an average predicted component concentration for each of the components of the target mixture.

In accordance with a second aspect, there is provided a system for determining predicted component concentrations of a target mixture. The system comprising: a mid-infrared waveguide sensor configured to measure absorption spectra; and a computer comprising a processor and a data storage storing computer program instructions operable to cause the processor to: receive, from the mid-infrared waveguide sensor, training absorption spectra for a plurality of training mixtures, the plurality of training mixtures each having one or more components associated with the target mixture and comprises different predetermined component concentrations; train a machine learning model using the training absorption spectra to obtain a trained machine learning model, the trained machine learning model being adapted to decompose an absorption spectrum of a mixture into component absorption spectra associated with components of the mixture, wherein the components of the mixture include one or more components of the target mixture; receive, from the mid-infrared waveguide sensor, a target absorption spectrum of the target mixture; decompose the target absorption spectrum into target component absorption spectra using the trained machine learning model, each of the target component absorption spectra being associated with a corresponding component of the target mixture and comprises a predetermined number of data points across measured wavelengths of the target absorption spectrum; receive, from the mid-infrared waveguide sensor, measured absorption spectra of each of the components of the target mixture, the measured absorption spectra include a series of measured absorption spectra of varying concentrations of a respective component; apply linear fitting to the measured absorption spectra of each of the components of the target mixture to determine predetermined wavelengths of the measured absorption spectra for comparison; and compare each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths.

By decomposing a target absorption spectrum into target component absorption spectra using a trained machine learning model, each of the target component absorption spectra associated with a corresponding component of the target mixture can be obtained. Further, by applying linear fitting to the measured absorption spectra of each of the components of the target mixture to determine predetermined wavelengths of the measured absorption spectra for comparison and comparing each of the target component absorption spectra with the measured absorption spectra of a corresponding component at the predetermined wavelengths, predicted component concentration for each of the components of the target mixture can be determined. This provides an additional or an alternative way to determine predicted component concentrations of a target mixture. Further, the target absorption spectrum can be decomposed into individual target component absorption spectra for each component of the target mixture for further analysis if required.

Wherein the predicted component concentration for each of the components of the target mixture may include a plurality of predicted component concentrations, each of the plurality of the predicted component concentrations being associated with a corresponding one of the predetermined wavelengths, the data storage of the computer may store computer program instructions operable to cause the processor to: average the plurality of predicted component concentrations to obtain an average predicted component concentration for each of the components of the target mixture.

In accordance with a third aspect, there is provided a computer-implemented method for determining predicted component concentrations of a target mixture. The method comprising: receiving, from a mid-infrared waveguide sensor, first training absorption spectra for a plurality of training mixtures, the plurality of training mixtures each having one or more components associated with the target mixture and comprises different component concentrations; training a first machine learning model using the first training absorption spectra to obtain a first trained machine learning model, the first trained machine learning model being adapted to classify an absorption spectrum of a mixture having one or more of the components associated with the target mixture to identify specific component concentrations of the mixture, the identified specific component concentrations being one of the different predetermined component concentrations; receiving, from the mid-infrared waveguide sensor, a target absorption spectrum of the target mixture; and determining the predicted component concentrations of the target mixture by classifying the target absorption spectrum using the first trained machine learning model.

The computer-implemented method may comprise: receiving, from the mid-infrared waveguide sensor, second training absorption spectra for the plurality of training mixtures; training a second machine learning model using the second training absorption spectra to obtain a second trained machine learning model, the second trained machine learning model being adapted to decompose the absorption spectrum of the mixture into component absorption spectra of the components of the mixture; and decomposing the target absorption spectrum into target component absorption spectra using the second trained machine learning model, each of the target component absorption spectra being associated with a corresponding component of the target mixture and comprises a predetermined number of data points across measured wavelengths of the target absorption spectrum.

The computer-implemented method may comprise: receiving, from the mid-infrared waveguide sensor, measured absorption spectra of each of the components of the target mixture, the measured absorption spectra of each of the components include a series of measured absorption spectra of varying concentrations of a respective component; applying linear fitting to the measured absorption spectra of each of the components to determine predetermined wavelengths of the measured absorption spectra for comparison; and comparing each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths.

Where the predicted component concentration for each of the components of the target mixture may include a plurality of predicted component concentrations, each of the plurality of the predicted component concentrations being associated with a corresponding one of the predetermined wavelengths, the computer-implemented method may comprise: averaging the plurality of predicted component concentrations to obtain an average predicted component concentration for each of the components of the target mixture.

The second machine learning model may include a multi-layer perceptron (MLP) regressor model.

The computer-implemented method may comprise: normalizing the first training absorption spectra and the target absorption spectrum with a buffer absorption spectrum of a buffer solution, the buffer solution being the buffer used in the plurality of training mixtures and the target mixture.

The first machine learning model may include a convolutional neural network (CNN).

The mid-infrared waveguide sensor may comprise a subwavelength grating (SWG) metamaterial waveguide formed on a substrate. By using the SWG metamaterial waveguide, the property of enhanced sensitivity from the SWG metamaterial can be leveraged for use to form a compact nanophotonic waveguide sensor. In this way, real-time monitoring of analyte and prolonged sensing operation can be achieved with a small footprint to fulfill the requirement of miniaturization, while obtaining high sensitivity and reduction of water absorption loss.

The subwavelength grating metamaterial waveguide may comprise a periodic arrangement of pillars and a period of the periodic arrangement is less than or equal to 800 nm.

An effective index of a propagation mode of the mid-infrared waveguide sensor may be higher than a refractive index of the substrate.

The target absorption spectrum may be measured in a mid-infrared wavelength range of 3.7 μm to 3.8 μm.

It should be appreciated that features relating to one aspect may be applicable to the other aspects. Embodiments provide a system and a computer-implemented method for determining predicted component concentrations of a target mixture. Particularly, by training a first machine learning model using training absorption spectra to obtain a first trained machine learning model adapted to classify an absorption spectrum of a mixture having one or more of the components associated with the target mixture, predicted component concentrations of a target mixture can be determined by classifying the target absorption spectrum using the first trained machine learning model. The first trained machine learning model is adapted to identify specific component concentrations using an absorption spectrum by classifying the absorption spectrum into one of the predetermined component concentrations used for training the first machine learning model. This provides an efficient and rapid way to identify and predict component concentrations in a target mixture using a target absorption spectrum of the target mixture.

In an embodiment, the target absorption spectrum can be decomposed into target component absorption spectra using a second trained machine learning model to obtain each of the target component absorption spectra associated with a corresponding component of the target mixture. Individual target component absorption spectra for each component of the target mixture can therefore be obtained for further analysis if required. Further, by applying linear fitting to the measured absorption spectra of each of the components of the target mixture to determine predetermined wavelengths of the measured absorption spectra for comparison and by comparing each of the target component absorption spectra with the measured absorption spectra of a corresponding component at the predetermined wavelengths, predicted component concentration for each of the components of the target mixture can also be determined. This provides a further way to determine predicted component concentrations of a target mixture, which can be used to identify, verify and/or confirm the predicted component concentrations of the target mixture obtained using the first machine learning model.

In an embodiment, a mid-infrared waveguide sensor comprising a subwavelength grating (SWG) metamaterial waveguide formed on a substrate can be used. By using the SWG metamaterial waveguide, the property of enhanced sensitivity from the SWG metamaterial can be leveraged for use to form a compact nanophotonic waveguide sensor. In this way, real-time monitoring of analyte and prolonged sensing operation can be achieved with a small footprint to fulfill the requirement of miniaturization, while obtaining high sensitivity and reduction of water absorption loss. This also supports the subsequent spectrum classification and decomposition executed by machine learning, as the higher sensitivity achieved provides greater distinguishability in the absorption spectra obtained for different mixture classes or concentration combinations.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

Embodiments will now be described, by way of example only, with reference to the following drawings, in which:

FIGS. 1A and 1B are schematic diagrams showing waveguide sensors and their working mechanisms in accordance with prior art, where FIG. 1A is a schematic diagram showing near-infrared (NIR) waveguide sensors sensing using resonant peak shifts and FIG. 1B is a schematic diagram showing mid-infrared (MIR) waveguide sensors using a transmission change of absorption peaks;

FIG. 2 is a schematic diagram showing an artificial intelligent (AI) enhanced metamaterial waveguide sensing platform (AIMWSP) for mid-infrared (MIR) sensing using an absorbance change in absorption spectra in accordance with an embodiment;

FIG. 3 is a block diagram showing a system for determining predicted component concentrations of a target mixture in accordance with an embodiment;

FIG. 4 is a block diagram of a computer of the system of FIG. 3 for determining predicted component concentrations of a target mixture in accordance with an embodiment;

FIG. 5 is a flowchart showing a computer-implemented method for determining predicted component concentrations of a target mixture in accordance with an embodiment;

FIG. 6 is a flowchart showing a computer-implemented method for decomposing a target absorption spectrum into target component absorption spectra in accordance with an embodiment;

FIG. 7 is a flowchart showing a computer-implemented method for obtaining an average predicted component concentration for each of the components of a target mixture using the target component absorption spectra obtained in the method of FIG. 6 in accordance with an embodiment;

FIG. 8 shows schematic diagrams of a mid-infrared waveguide sensor in accordance with an embodiment;

FIG. 9 shows a diagram to illustrate computer-implemented methods for use in determining component concentrations and mixture spectrum decomposition in accordance with embodiments;

FIG. 10 shows a false colored scanning electron microscopy (SEM) image of a portion of a subwavelength grating (SWG) metamaterial waveguide in accordance with an embodiment;

FIG. 11 shows a graph of simulated effective index with respect to a duty cycle of a SWG metamaterial waveguide having a width (W) of 1.5 μm for different periods (∧) in accordance with an embodiment;

FIG. 12 shows a graph of simulated propagation loss with respect to a duty cycle of a SWG metamaterial waveguide having a width (W) of 1.5 μm for different periods (∧) in accordance with an embodiment;

FIG. 13 shows a schematic of a simulation model for use in acquiring the square of electric field magnitude |E|² in respective regions of a SWG metamaterial waveguide in accordance with an embodiment;

FIG. 14 shows a graph of simulated group index n_{g} as a function of the period and the duty cycle of a SWG metamaterial waveguide using the simulation model of FIG. 13 in accordance with an embodiment;

FIG. 15 shows a graph of calculated external confinement factor Γ with respect to the period and the duty cycle of a SWG metamaterial waveguide using the simulation model of FIG. 13 in accordance with an embodiment;

FIGS. 16A, 16B and 16C show simulated distributions of electric field magnitude |E| of a SWG metamaterial waveguide using the simulation model of FIG. 13 in accordance with an embodiment, where FIG. 16A shows a simulated distribution of electric field magnitude for the X-Y cross-section, FIG. 16B shows a simulated distribution of electric field magnitude for the Y-Z cross-section in the gap region and FIG. 16C shows a simulated distribution of electric field magnitude for the Y-Z cross-section in the pillar region;

FIG. 17 shows a schematic of a planar side view of the SWG metamaterial waveguide of FIG. 10 in accordance with an embodiment;

FIG. 18 shows simulated distributions of electric field magnitude |E| of a SWG metamaterial waveguide using the simulation model of FIG. 13 in the X-Z cross-section in accordance with an embodiment;

FIGS. 19A, 19B and 19C show graphs of normalized output versus time to illustrate dynamic monitoring of different components in a mixture in accordance with an embodiment, where FIG. 19A shows a graph of normalized output versus time to illustrate dynamic monitoring of acetone, FIG. 19B shows a graph of normalized output versus time to illustrate dynamic monitoring of isopropyl alcohol (IPA) and FIG. 19C shows a graph of normalized output versus time to illustrate dynamic monitoring of glycerin;

FIGS. 20A, 20B and 20C show graphs of absorbance difference (Δ Absorbance) between water and various analytes versus analyte concentrations for a plurality of mixtures in accordance with embodiments, where FIG. 20A shows a graph of absorbance difference (Δ Absorbance) between water and acetone versus acetone concentration, FIG. 20B shows a graph of absorbance difference (Δ Absorbance) between water and IPA versus IPA concentration and FIG. 20C shows a graph of absorbance difference (Δ Absorbance) between water and glycerin versus glycerin concentration;

FIG. 21 shows a graph of absorbance difference (Δ Absorbance) between water and acetone versus acetone concentration for a strip waveguide sensor and a SWG metamaterial waveguide sensor in accordance with an embodiment;

FIG. 22 shows a graph of simulated confinement factor in air versus a thickness of silicon residual between silicon pillars of a SWG metamaterial waveguide in accordance with an embodiment;

FIG. 23 shows a schematic diagram of a testing setup for measuring absorption spectra of different mixtures with varying component concentrations in accordance with an embodiment;

FIG. 24 shows a graph of normalized signal versus a laser output wavelength of the training absorption spectra used in training a first machine learning model in accordance with an embodiment;

FIGS. 25A, 25B, 25C and 25D show graphs of normalized signal versus a laser output wavelength of the training absorption spectra for mixtures of sixty-four concentration combinations as used for the training of the first machine learning model in accordance with an embodiment, where FIG. 25A shows a graph of normalized signal versus the laser output wavelength for mixtures having 0 vol % of acetone and with varying concentrations of IPA and glycerin, FIG. 25B shows a graph of normalized signal versus the laser output wavelength for mixtures having 5 vol % of acetone and with varying concentrations of IPA and glycerin, FIG. 25C shows a graph of normalized signal versus the laser output wavelength for mixtures having 10 vol % of acetone and with varying concentrations of IPA and glycerin and FIG. 25D shows a graph of normalized signal versus the laser output wavelength for mixtures having 15 vol % of acetone and with varying concentrations of IPA and glycerin;

FIG. 26 is a schematic structure of a first machine learning model, a convolutional neural network (CNN), used in the computer-implemented method of FIG. 5 for determining predicted component concentrations of a target mixture in accordance with an embodiment;

FIG. 27 is a comparison table for labeling mixtures having different mixing ratios for use with the CNN model of FIG. 26 in accordance with an embodiment;

FIG. 28 shows a bar chart of testing accuracy using the CNN model for the sixty-four labelled mixtures of FIG. 27 in accordance with an embodiment;

FIG. 29 shows a graph of noise (μV) as a function of signal intensity (μV) for calculating limit of detection (LoD) of glycerin in accordance with an embodiment;

FIGS. 30A, 30B and 30C show empirical results in relation to distinguishing four concentrations of glycerin lower than the LoD in accordance with an embodiment, where FIG. 30A shows graphs of normalized output versus time to illustrate monitoring of a liquid switching process from water to 300 ppm, 600 ppm and 900 ppm glycerin solutions at a wavelength of 3.77 μm, FIG. 30B shows graphs of normalized absorption spectra of water, 300 ppm, 600 ppm and 900 ppm glycerin solutions with varying laser output wavelengths, and FIG. 30C shows a confusion matrix for recognizing the four trace glycerin concentrations;

FIGS. 31A, 31B, 31C and 31D show visualizations of principal component analysis (PCA) results of the absorption spectra measured for four trace glycerin concentrations of 0 ppm, 300 ppm, 600 ppm and 900 ppm glycerin solutions in accordance with an embodiment, where FIG. 31A shows a visualization of the analyzed absorption spectra projected in three-dimensional (3D) principal components (PC) space where each point represents one spectrum, FIG. 31B shows a visualization of the analyzed absorption spectra projected in the PC1-PC2 plane, FIG. 31C shows a visualization of the analyzed absorption spectra projected in the PC1-PC3 plane, and FIG. 31D shows a visualization of the analyzed spectra projected in the PC2-PC3 plane;

FIG. 32 shows a normalized absorption spectrum of a mixture versus laser output wavelength to illustrate an example of an input to a second machine learning model in accordance with an embodiment;

FIG. 33 shows a structure of the second machine learning model, a multilayer perceptron (MLP) regressor, for decomposing an absorption spectrum into component absorption spectra in accordance with an embodiment;

FIGS. 34A, 34B and 34C show graphs of normalized signal versus laser output wavelength in relation to decomposed component absorption spectra of the mixture of FIG. 32 as output by the MLP regressor of FIG. 33, where FIG. 34A shows decomposed component absorption spectra data for acetone, FIG. 34B shows decomposed component absorption spectra data for IPA and FIG. 34C shows decomposed component absorption spectra data for glycerin;

FIG. 35 shows a graph of cost function (i.e., mean squared error (MSE)) as a function of training epoch in relation to forty-eight absorption spectra for forty-eight mixtures of a training data set in accordance with an embodiment;

FIGS. 36A, 36B and 36C show graphs of decomposition error for sixteen component absorption spectra of a testing data set in accordance with an embodiment, where FIG. 36A shows a graph of decomposition error for sixteen acetone component absorption spectra, FIG. 36B shows a graph of decomposition error for sixteen IPA component absorption spectra and FIG. 36C shows a graph of decomposition error for sixteen glycerin component absorption spectra;

FIG. 37 shows a flowchart for predicting component concentration using decomposed component absorption spectra in accordance with an embodiment;

FIG. 38 shows a graph of mean R-square values calculated using measured absorption spectra of acetone, IPA and glycerin at selected eight wavelengths in accordance with an embodiment;

FIGS. 39A, 39B, 39C show graphs of absorbance difference (Δ Absorbance) between water and an analyte concentration using measured absorption spectra in accordance with embodiments, where FIG. 39A shows a graph of absorbance difference (Δ Absorbance) versus acetone concentration, FIG. 39B shows a graph of absorbance difference (Δ Absorbance) versus IPA concentration and FIG. 39C shows a graph of absorbance difference (Δ Absorbance) versus glycerin concentration;

FIGS. 40A, 40B, 40C show graphs of predicted analyte concentration for different expected analyte concentrations (i.e. ground truth) as determined using the MLP regressor of FIG. 33 in accordance with an embodiment, where FIG. 40A shows a graph of predicted acetone concentration versus the expected acetone concentration, FIG. 40B shows a graph of predicted IPA concentration versus the expected IPA concentration and FIG. 40C shows a graph of predicted glycerin concentration versus the expected glycerin concentration;

FIGS. 41A and 41B show three-dimensional (3D) visualizations of ten predicted concentration combinations and their corresponding expected concentration combinations (i.e. ground truth), where FIG. 41A shows a 3D visualization of ten predicted concentration combinations and their corresponding expected concentration combinations (i.e. ground truth) for a training data set and FIG. 41B shows a 3D visualization of ten predicted concentration combinations and their corresponding expected concentration combinations (i.e. ground truth) for a test data set; and

FIG. 42 shows a histogram of prediction root-mean square error (RMSE) for sixteen concentration combinations of the test data set in accordance with an embodiment.

### DETAILED DESCRIPTION

A description of example embodiments follows:

Exemplary embodiments relate to a system and a computer-implemented method for determining predicted component concentrations of a target mixture.

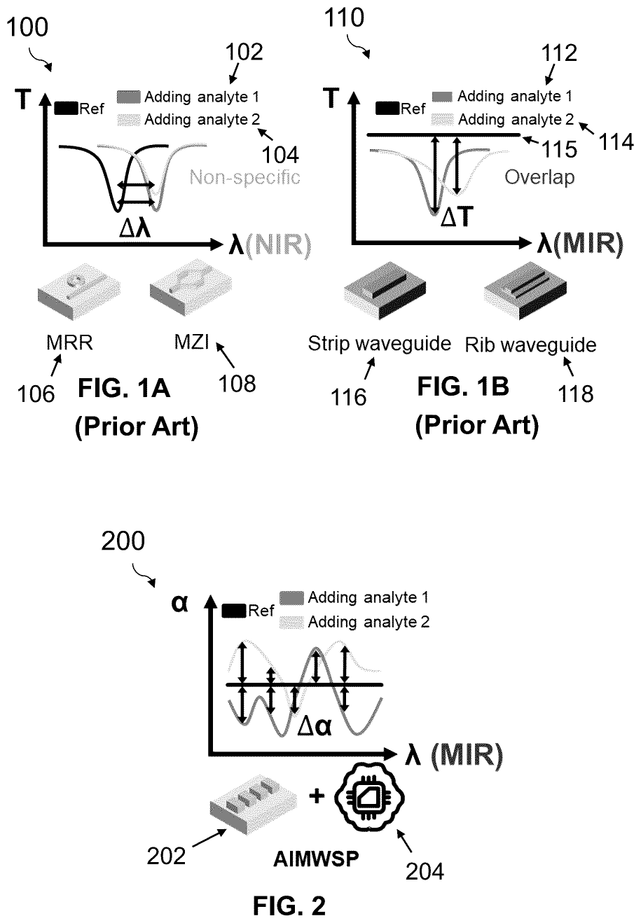

FIGS. 1A and 1B are schematic diagrams showing waveguide sensors and their working mechanisms in accordance with prior art.

FIG. 1A is a schematic diagram 100 showing near-infrared (NIR) waveguide sensor sensing using resonant peak shifts. As shown in the schematic diagram 100, by introducing an analyte 1 102 or an analyte 2 104, a shift of the resonant peak Δλ can be detected to sense for a presence of an analyte 1 102 or an analyte 2 104. However, as shown in the schematic diagram 100, the shift of the resonant peak Δλ as detected by a NIR waveguide sensor is not specific to an identity of the analyte 1 102 or analyte 2 104 as Δλ is similar in both cases. Examples of NIR waveguide sensors include a micro-ring resonator (MRR) 106 and a Mach-Zehnder Interferometer 108 as shown in FIG. 1A.

FIG. 1B is a schematic diagram 110 showing mid-infrared (MIR) waveguide sensors using a transmission change of absorption peaks. As shown in the schematic diagram 110, there is still overlap of the absorption peaks for the analyte 1 112 and the analyte 2 114 which makes quantitative analysis of complex liquid mixtures challenging. Further, a background 115 is present in the spectra which can potentially mask the absorption peaks of the analytes. For example, water which is commonly present in aqueous mixtures provides a strong absorption background which can further complicate quantitative analysis of complex aqueous mixtures. Examples of MIR waveguide sensors include a strip waveguide 116 and a rib waveguide 118.

FIG. 2 is a schematic diagram 200 showing an artificial intelligent (AI) enhanced metamaterial waveguide sensing platform (AIMWSP) for mid-infrared (MIR) sensing of aqueous mixtures using an absorbance change (Δ Absorbance) in absorption spectra in accordance with an embodiment. As compared to the schematic diagram 110 of FIG. 1B, the present AIMWSP uses Δ Absorbance of at least a portion of the absorption spectra within a selected wavelength range to determine a presence and a concentration of each components (or analyte) in a complex mixture.

Metamaterials has been used in designing various photonic devices, including a tunable actuator, meta-lens, and meta-waveguides, with improved device efficiency. In the present embodiment, a SWG metamaterial waveguide sensor 202 is used due to the flexibility in controlling a mode profile and an effective refractive index (RI) for tuning a sensitivity of the SWG metamaterial waveguide sensor 202. With the proper design of the metamaterial-based waveguide sensor 202, it is possible to promote sensitivity in a limited space for fulfilling the miniaturized requirement while avoiding excessive attenuation from water.

Besides using a SWG metamaterial waveguide sensor for miniaturized sensitive sensing, one or more machine learning models 204 are used in embodiments of the present disclosure for analyzing measured absorption spectra received from the SWG metamaterial waveguide sensor.

Machine learning has been used for data analysis in research fields ranging from data science to engineering applications. Multifarious types of classic algorithm, such as principal component analysis (PCA) and support vector machines (SVM), have been adopted in several optical sensors for multicomponent analysis. For example, the combination of an infrared nanoantenna and PCA was reported for the classification of a glucose/fructose solution in different concentrations. However, although mixtures in arbitrary mixing ratios can be identified using this PCA-based nanoantenna with the mixture spectrum as input, the individual spectrum response of each component with respective concentrations is still missing. Further, an available wavelength range in the MIR waveguide sensor is narrower as compared with a nanoantenna, and how to efficiently leverage a mixture absorption spectrum having a limited wavelength range is still one of the obstacles faced to achieve accurate mixture analysis in waveguide sensors.

In the present embodiment, absorption spectra as measured using the SWG metamaterial waveguide sensor are analyzed using machine learning models 204 to determine a presence and a concentration of each components (or analyte) in a complex mixture. Compared with a resonant spectrum, an absorption spectrum in the MIR region contains more distinctive information about a molecule and this is leveraged in embodiments of the present disclosure. In an embodiment, a machine learning model, such as a convolutional neural network (CNN), is used to effectively recognize signatures of absorption spectra (for example, with respect to absorbance change with reference to a background) for mixtures having different component combinations. In another embodiment, by executing an MLP regressor, absorption spectrum of a mixture can be decomposed into absorption spectra of pure components of the mixture. As will be shown later, it is possible to not only uncover the absorption spectrum of each of the pure components buried in a mixture absorption spectrum for a limited wavelength range but also to determine individual component concentrations by fully leveraging the absorption spectrum of pure components in the targeted spectral region.

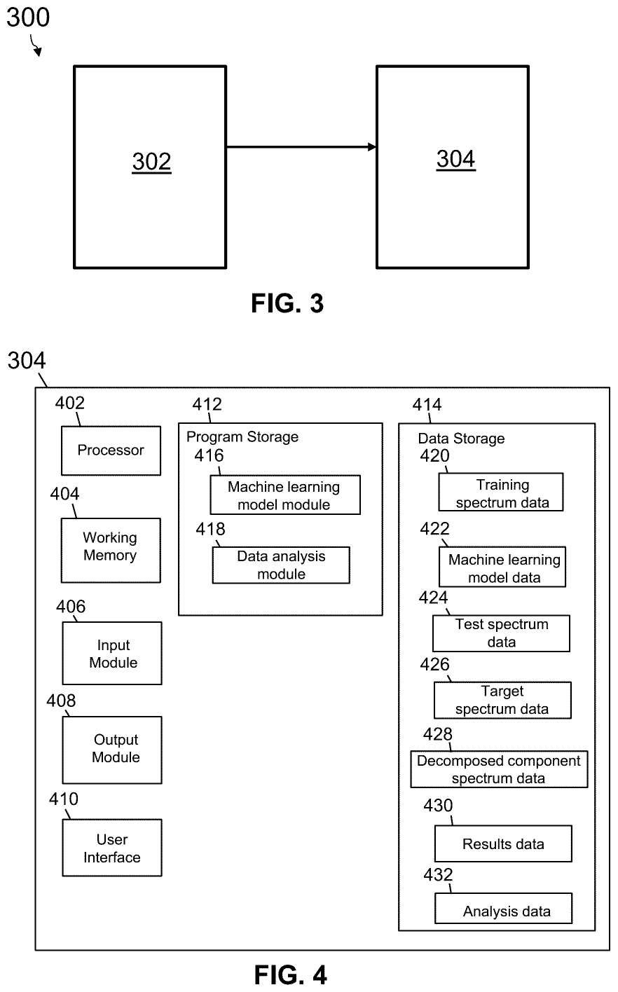

FIG. 3 is a block diagram showing a system 300 for determining predicted component concentrations of a target mixture in accordance with an embodiment. In the present embodiment, the system 300 comprises a mid-infrared (MIR) waveguide sensor 302 configured to measure absorption spectra of a mixture, particularly an aqueous mixture with different components. The aqueous mixture can be a binary, a tertiary, a quaternary or a quinary mixture but is not limited as such. In an embodiment, the MIR waveguide sensor 302 comprises a subwavelength grating metamaterial waveguide formed on a substrate. This will be discussed in relation to FIGS. 10 to 18 below.

The MIR waveguide sensor 302 is adapted to provide absorption spectra, such as training absorption spectra, test absorption spectra and/or target absorption spectra, to a computer 304 for training one or more machine learning models and/or for spectral data analysis. The computer 304 includes one or more machine learning models for analyzing the absorption spectra received from the MIR waveguide sensor 302. The machine learning models include one or more of: a convolutional neural network (CNN) and a multi-layer perceptron (MLP) regressor model. Details for the computer 304 for use in the system 300 is discussed in relation to FIG. 4 below.

FIG. 4 is a block diagram of the computer 304 of the system 300 of FIG. 3 for determining predicted component concentrations of a target mixture in accordance with an embodiment.

As shown in FIG. 4, the computer 304 includes a computer system with memory that stores computer program modules which implement computer-implemented method for determining predicted component concentrations of a target mixture. The computer 304 comprises a processor 402, a working memory 404, an input module 406, an output module 408, a user interface 410, program storage 412 and data storage 414. The processor 402 may be implemented as one or more central processing unit (CPU) chips. The program storage 412 is a non-volatile storage device such as a hard disk drive which stores computer program modules. The computer program modules are loaded into the working memory 404 for execution by the processor 402. The input module 406 is an interface which allows data, for example absorption spectra related to training data sets, testing data sets, target data sets etc., to be received by the computer 304. The input module 406 may include a network interface for receiving data. The network interface may be a wireless network interface such as Wi-Fi or Bluetooth interface, alternatively it may be a wired interface. The output module 408 is an output device which allows data and simulation results of the computer 304 to be output. The output module 408 may be coupled to a display device or a printer. The output module 408 may include a display adapted to display a dashboard showing predicted component concentrations of a target mixture and/or decomposed component absorption spectra of a target mixture generated by the computer 304. The user interface 410 allows a user of the computer 304 to input selections and commands and may be implemented as a graphical user interface.

The program storage 412 stores machine learning model module 416 and a data analysis module 418. The machine learning model module 416 include one or more machine learning models, such as a convolutional neural network (CNN) and a multi-layer perceptron (MLP) regressor model, for determining predicted component concentrations of a target mixture and/or decomposing an absorption spectrum of a target mixture into its component absorption spectra. The data analysis module 418 includes data analysis tools, such as for linear fitting and for calculating mean-square errors etc., for processing spectral data obtained from the SWG metamaterial waveguide sensor 302 and/or from the machine learning models (e.g., decomposed component absorption spectra). These computer program modules 416, 418 cause the processor 402 to execute various analytical and simulation processes which are described in more detail below. The program storage 412 may be referred to in some contexts as computer readable storage media and/or non-transitory computer readable media. As depicted in FIG. 4, the computer program modules 416, 418 are distinct modules which perform respective functions implemented by the computer 304. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

The data storage 414 stores various data. In the present embodiment, as shown in FIG. 4, the data storage 414 has storage for training spectrum data 420, machine learning model data 422, test spectrum data 424, target spectrum data 426, decomposed component spectrum data 428, results data 430, and analysis data 432. The training spectrum data 420 includes a set of absorption spectra for use in training the machine learning model module 416. The set of absorption spectra are measured using a plurality of training mixtures each having one or more components associated with a target mixture, and each of these plurality of training mixtures comprises different predetermined component concentrations. The machine learning model data 422 includes data or parameters associated with the machine learning models used for processing absorption spectral data received from the SWG metamaterial waveguide sensor 302, as well as data or parameters associated with the trained machine learning models. The test spectrum data 424 includes testing absorption spectra for testing the trained machined learning models. In an embodiment where the MLP regressor model was used, the testing absorption spectra may include concentration combinations that were not included in the training absorption spectra used for training the MLP regressor model. The target spectrum data 426 includes absorption spectrum of a target mixture to be analyzed by the system 300 for determining predicted component concentrations of a target mixture. The decomposed component spectrum data 428 includes target component absorption spectra of a target mixture decomposed using a trained machine learning model, such as the MLP regressor model. The results data 430 includes predicted component concentrations of a target mixture as determined using one or more machine learning models and/or analyzed results obtained using the data analysis module 418. The analysis data 432 includes parameters or data used by the data analysis module 418 for analyzing spectral data in relation to the result data 430 and/or the decomposed component spectrum data 428.

It should be appreciated that the computer 304 can be implemented as a stand-alone computer system or as part of a server or a virtual machine. In embodiments where the computer 304 is part of a server or a virtual machine, the computer 304 (e.g. the modules or machine learning models therein) can be assessed through a Web (Cloud) Application.

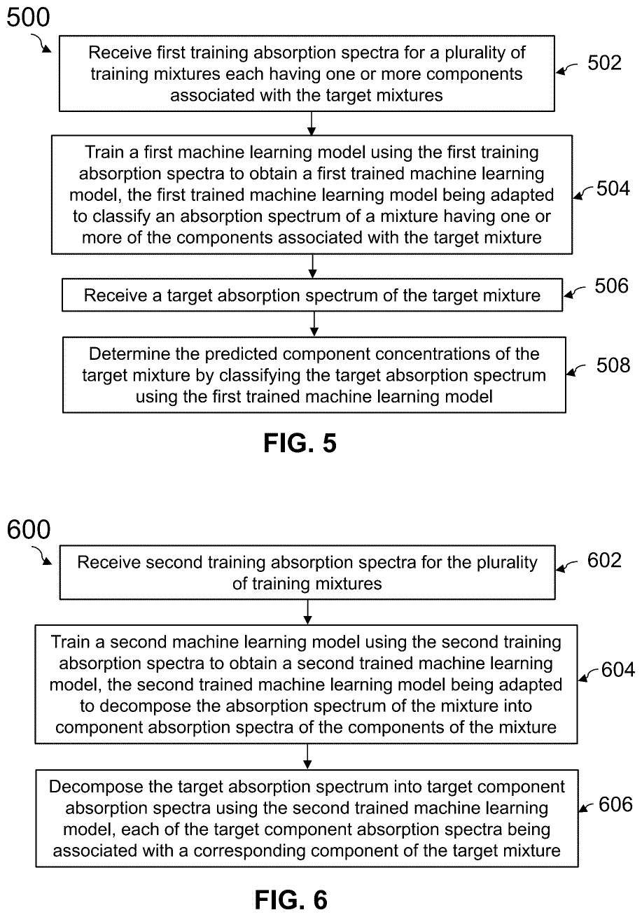

FIG. 5 is a flowchart showing a computer-implemented method 500 for determining predicted component concentrations of a target mixture in accordance with an embodiment.

In step 502, the computer 304 is configured to receive, from the mid-infrared waveguide sensor 302, first training absorption spectra for a plurality of training mixtures. The plurality of training mixtures each has one or more components associated with the target mixture and comprises different predetermined component concentrations. For example, the target mixture may be an aqueous mixture which includes acetone, isopropyl alcohol (IPA) and glycerin in water. The plurality of training mixtures in this case include a plurality of mixtures with different concentration combinations of acetone, IPA and glycerin in water. This will be discussed in detail in relation to the following figures.

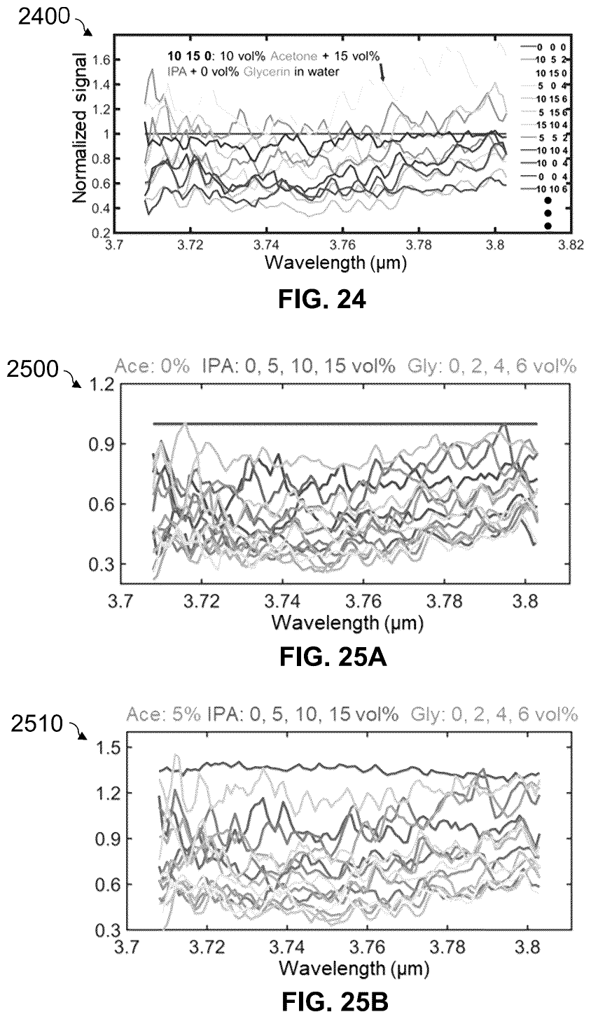

In step 504, the machine learning model module 416 is executed by the processor 402 to train a first machine learning model using the first training absorption spectra to obtain a first trained machine learning model. The first trained machine learning model is adapted to classify an absorption spectrum of a mixture having one or more of the components associated with the target mixture to identify specific component concentrations of the mixture, where the identified specific component concentrations is one of the different predetermined component concentrations used for the training of the first machine learning model in the step 502. In an embodiment, the first machine learning model includes a convolutional neural network (CNN) which is trained to classify an absorption spectrum of a mixture into one of the component concentration combinations of the training absorption spectra. This will be discussed in more detail in relation to FIGS. 24 to 30C below.

In step 506, the computer 304 is configured to receive, from the mid-infrared waveguide sensor 302, a target absorption spectrum of the target mixture.

In step 508, the machine learning module 416 is executed by the processor 402 to determine the predicted component concentrations of the target mixture by classifying the target absorption spectrum using the first trained machine learning model. In an embodiment where the first machine learning model includes the CNN, the CNN is adapted to classify the target absorption spectrum into a class of one of the predetermined component concentrations, and the predicted component concentrations of the target mixture can be determined or identified based on the label or class of the predetermined component concentrations that the target absorption spectrum is classified in.

FIG. 6 is a flowchart showing a computer-implemented method 600 for decomposing a target absorption spectrum into target component absorption spectra in accordance with an embodiment.

In step 602, the computer 304 is configured to receive, from the mid-infrared waveguide sensor 302, second training absorption spectra for the plurality of training mixtures. In an embodiment, the second training absorption spectra includes a subset of the first training absorption spectra. The training mixtures, for use to provide either the first training absorption spectra or the second training absorption spectra, each has one or more components associated with the target mixture and comprises different predetermined component concentrations.

In step 604, the machine learning model module 416 is executed by the processor 402 to train a second machine learning model using the second training absorption spectra to obtain a second trained machine learning model. The second trained machine learning model is adapted to decompose the absorption spectrum of the mixture into component absorption spectra associated with components of the mixture. In an embodiment, the second trained machine learning model includes an MLP regressor model.

In step 606, the machine learning model module 416 is executed by the processor 402 to decompose the target absorption spectrum into target component absorption spectra using the second trained machine learning model. Each of the target component absorption spectra is associated with a corresponding component of the target mixture and comprises a predetermined number of data points across measured wavelengths of the target absorption spectrum. Using a similar example of a target mixture being an aqueous mixture which includes acetone, isopropyl alcohol (IPA) and glycerin in water, the target component absorption spectra obtained by decomposing the target absorption spectrum includes an absorption spectrum of acetone, an absorption spectrum of IPA and an absorption spectrum of glycerin. Each of the target component absorption spectra comprises data points at the measured wavelengths of the target absorption spectrum. The data points therefore represent their corresponding target component absorption spectrum.

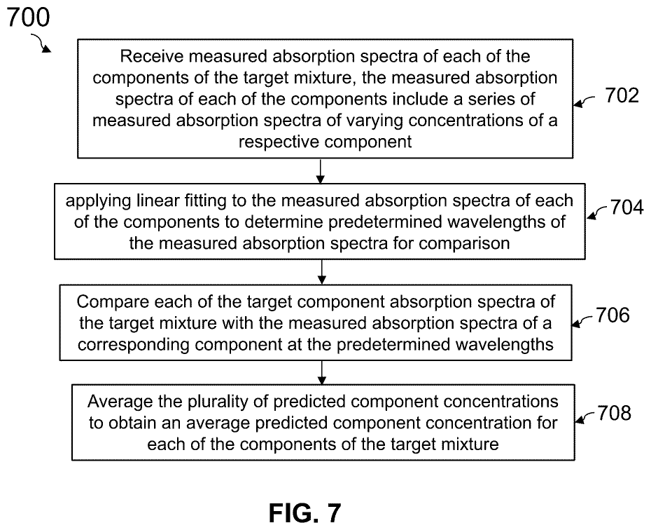

FIG. 7 is a flowchart showing a computer-implemented method 700 for obtaining an average predicted component concentration for each of the components of a target mixture using the target component absorption spectra obtained in the method of FIG. 6 in accordance with an embodiment.

In step 702, the computer 304 is configured to receive, from the mid-infrared waveguide sensor 302, measured absorption spectra of each of the components of the target mixture, the measured absorption spectra of each of the components include a series of measured absorption spectra of varying concentrations (e.g. in volume percent (vol %)) of a respective component. Following from the above example, for an embodiment where a target mixture is an aqueous mixture comprising acetone, isopropyl alcohol (IPA) and glycerin in water, the measured absorption spectra of each of the components include absorption spectra for acetone, absorption spectra for IPA and absorption spectra for glycerin. The absorption spectra for acetone, IPA and glycerin are each of varying analyte concentrations in volume percent (vol %).

In step 704, the data analysis module 418 is executed by the processor 402 to apply linear fitting to the measured absorption spectra of each of the components to determine predetermined wavelengths of the measured absorption spectra for comparison. By applying the linear fitting to the measured absorption spectra of each of the components, sensitivity of data points at the measured wavelengths of the target absorption spectrum can be determined and this can be used to determine the predetermined wavelengths for the subsequent comparison step.

In step 706, the data analysis module 418 is executed by the processor 402 to compare each of the target component absorption spectra of the target mixture with the measured absorption spectra of a corresponding component at the predetermined wavelengths to determine a predicted component concentration for each of the components of the target mixture. The predicted component concentration is associated with a concentration of the corresponding component having the measured absorption spectrum that best fits the target component absorption spectrum of the corresponding component of the target mixture at the predetermined wavelengths.

In an embodiment where the predicted component concentration for each of the components of the target mixture includes a plurality of predicted component concentrations where each of the plurality of the predicted component concentrations is associated with a corresponding one of the predetermined wavelengths, the data analysis module 418 is executed by the processor 402, in step 708, to average the plurality of predicted component concentrations to obtain an average predicted component concentration for each of the components of the target mixture.

### Operation of the System 300

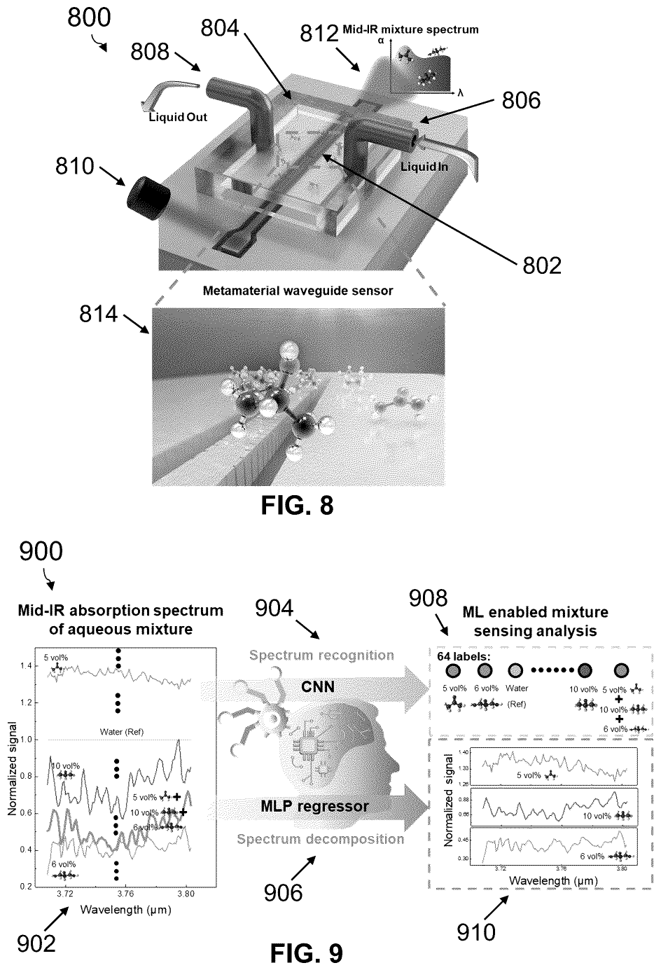

The working principle of the system 300 for aqueous mixture spectrum analysis is illustrated in relation to FIGS. 8 and 9.

FIG. 8 shows schematic diagrams in relation to a mid-infrared waveguide sensor 800 in accordance with an embodiment. As shown in FIG. 8, in the present embodiment, the mid-infrared waveguide sensor 800 includes a SWG metamaterial waveguide 802 enclosed by a chamber 804. The chamber 804 is made of polydimethylsiloxane (PDMS) in the present embodiment. The SWG metamaterial waveguide 802 is immersed in a liquid mixture (e.g. an aqueous mixture) for which an absorption spectrum is to be obtained. The PDMS chamber 804 is fluidly connected with an inlet 806 and an outlet 808. The inlet 806 is adapted to provide the liquid mixture into the PDMS chamber 804 for absorption spectral measurement and the outlet 808 is adapted to allow the liquid mixture out of the PDMS chamber 804. This may be facilitated, for example, by using a syringe connected to the inlet 806. In the present embodiment, each of the inlet 806 and the outlet 808 includes a stainless-steel tube bent at 90° as shown in FIG. 8 but other suitable materials for the tube can be used. An input mid-infrared (MIR) light 810 is provided to the SWG metamaterial waveguide 802 and propagates along the SWG metamaterial waveguide 802, interacting with the liquid mixture in the PDMS chamber 804. The interacted light 812 which has passed through the PDMS chamber 804 along the SWG metamaterial waveguide 802 is captured using a photo-detector (not shown) to measure an absorption spectrum of the liquid mixture. By sweeping the wavelength of the input MIR light 810, a MIR absorption spectrum which contains spectral information of the liquid mixture can be acquired using the mid-infrared waveguide sensor 800. The enlarged diagram 814 shows interaction of molecules of analytes in the liquid mixture with the SWG metamaterial waveguide 802.

In the present embodiment, the SWG metamaterial waveguide sensor 800 was fabricated on a silicon-on-insulator (SOI) substrate with a 500 nm thick silicon (Si) device layer. First, a pattern for the waveguide was defined using standard electron-beam lithography (EBL) with a suitable e-beam resist. In the present embodiment, the pattern comprises a total length of 660 μm of SWG metamaterial waveguide with two 40-μm-long mode converters incorporated into a strip waveguide, considering the trade-off between the higher sensitivity and the increased propagation loss from water absorption. Then the pattern was transferred to the Si device layer by deep reactive-ion etching (DRIE) using a gas mixture of SF₆, C₄F₈ and argon (Ar) followed by e-beam resist removal. In the present embodiment, the etched sample was submerged in a solvent stripper at 65° C. for 45 min. For the fabrication of the PDMS chamber 804, the PDMS base and agent with a mixing ratio of 10:1 were poured into a chamber mold and casted by 3D printing. After evacuating the air dissolved in the PDMS using a vacuum chamber, the PDMS chamber 804 was placed on a hot plate at 80° C. for 1.5 hours for curing and was subsequently peeled off from the chamber mold. A chip having the patterned Si device layer comprising the SWG metamaterial waveguide and the PDMS chamber 804 were sent into an oxygen plasma reactor for surface activation. With the help of alignment markers, the PDMS chamber 804 was bonded onto the surface of the chip under the view of the microscope within a short time after the chip was taken out from the oxygen plasma reactor. The PDMS chamber 804 bonded on the surface of the chip form a microfluidic channel and provide a sensing area covering only 2 mm of a total waveguide length, including the 660 μm SWG metamaterial waveguide. As shown in relation to FIG. 8, the SWG metamaterial waveguide 802 was covered by the 2 mm wide microfluidic channel provided by the PDMS chamber 804.

FIG. 9 shows a diagram 900 to illustrate computer-implemented methods for use in recognizing concentration combinations and mixture spectrum decomposition in accordance with embodiments.

After measuring the MIR absorption spectrum of the liquid mixture using the mid-infrared waveguide sensor 800 (as shown at 902 in FIG. 9), data associated with the MIR absorption spectrum is provided to the computer 304 for analysis. In the present embodiment, a CNN model 904 and an MLP regressor model 906 are used. The CNN model 904 is trained to recognize mixtures having different component concentration combinations and is then used to determine a concentration of each component in the mixture as shown at 908. The MLP regressor model 906 is used to decompose the MIR absorption spectrum of the liquid mixture into the component absorption spectra (i.e. pure forms) as shown at 910 which can be used to determine predicted component concentrations. Further details in relation to these machine learning models are provided in relation to FIGS. 24 to 42 below.

To achieve a highly sensitive sensor with a small footprint and to avoid adopting a complicated fabrication process, embodiments of the present disclosure use a SWG metamaterial waveguide which enables direct access to engineering an effective index and a mode profile of the waveguide for utilizing in the SWG metamaterial waveguide sensor. Design of the SWG metamaterial waveguide is discussed in relation to FIGS. 10 to 18.

FIG. 10 shows a false colored scanning electron microscopy (SEM) image 1000 of a portion of the subwavelength grating (SWG) metamaterial waveguide 802 in accordance with an embodiment. As shown in the SEM image 1000, the SWG metamaterial waveguide 802 in the present embodiment includes a plurality of Si blocks or pillars 1002 where each of the pillars 1002 are separated from one another by a gap 1004.

There are two main parameters for the geometry design of a SWG metamaterial waveguide, namely a period (∧) 1006 and a duty cycle (DC). The duty cycle (DC) is defined as a ratio of a length of a pillar L 1008 to the ∧ 1006, as shown in FIG. 10. In order to prevent Bragg reflection, the ∧ 1006 is designed to be smaller than the Bragg period. In the present embodiments, the period ∧ 1006 is less than or equal to 800 nm to ensure the SWG metamaterial waveguide works in the subwavelength regime. Concurrently, it is desired that an effective index of a propagation mode of the SWG metamaterial waveguide 802 is at least higher than the refractive index of the SiO₂ layer of the SOI substrate to prevent the optical mode being leaked to the MIR-absorptive SiO₂ layer. A width (W) 1010 of the SWG metamaterial waveguide 802 is also indicated in the SEM image 1000. A scale of 500 nm 1012 is also indicated.

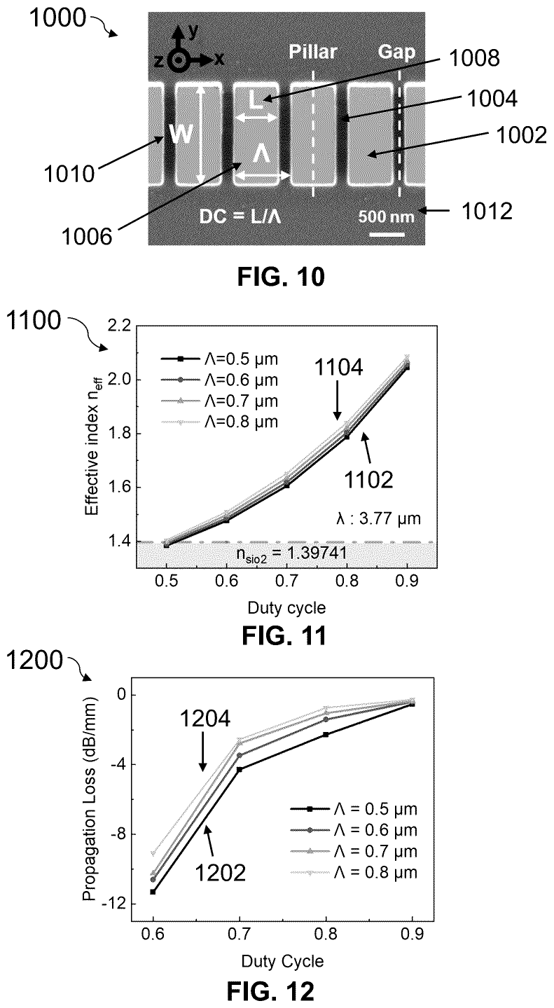

To investigate a relationship of the effective index n_{eff} of the SWG metamaterial waveguide 802 and propagation loss with respect to the period ∧ and the duty cycle (DC), three-dimensional (3D) Finite Difference Time Domain (FDTD) simulation was performed at a wavelength of 3.77 μm (where the absorption peak of IPA is located) for the input MIR light 810. This is shown in relation to FIGS. 11 and 12.

For the FDTD simulation performed, it was implemented using the FDTD method (Lumerical Inc.). For the simulation of an effective index of the propagation mode of the SWG metamaterial waveguide 802, one SWG metamaterial unit (i.e., one Si pillar+a gap) on a SiO₂ substrate with Bloch boundary condition at the x-boundaries and perfectly matched layer conditions at the y- and z-boundaries was built as the model. A plane wave as the light source is normally incident to the SWG metamaterial unit in the z-direction. By operating the “band-structure” function from the analysis group to extract the phase velocity from band diagrams, the effective index of the propagation mode under a certain SWG metamaterial geometry can be obtained. The mesh spacing in the x-direction is changed with the period and the duty cycle, and was set as 0.1×period×(1−duty cycle) in the gap region and 0.1×period×duty cycle in the Si pillar region. In the y- and z-direction, the mesh size was set as 150 and 100 nm, respectively.

FIG. 11 shows a graph 1100 of simulated effective index n_{eff} with respect to a duty cycle of the SWG metamaterial waveguide 802 having a width (W) of 1.5 μm for different periods (∧) in accordance with an embodiment. As shown in the graph 1100, the effective index n_{eff} of the propagation mode the SWG metamaterial waveguide 802 increases with increasing duty cycle and increasing period ∧. For example, a plot 1102 is shown for a period ∧ of 0.5 μm while a plot 1104 is shown for a period ∧ of 0.8 μm.

FIG. 12 shows a graph 1200 of simulated propagation loss with respect to a duty cycle of the SWG metamaterial waveguide 802 having a width (W) of 1.5 μm for different periods (∧) in accordance with an embodiment. As shown in the graph 1200, the propagation loss decreases (i.e., become less negative) with increasing duty cycle and increasing period ∧. For example, a plot 1202 is shown for a period ∧ of 0.5 μm while a plot 1204 is shown for a period ∧ of 0.8 μm.

From the simulated results of the graphs 1100, 1200, it can be inferred that with a gradual increase of the effective index n_{eff} resulting from increments of ∧ and/or DC (greater than the n_{SiO}_{₂}), the value of propagation loss starts to decrease in magnitude because the leakage loss from the absorption of SiO₂ is reduced as the mode is more confined within the SWG metamaterial waveguide 802.

Another parameter that is considered for the SWG metamaterial waveguide 802 is the external confinement factor Γ, which measures the degree of light-matter interactions and plays a role in the Beer-Lambert's law (see Equation (1) below):

T=I_{analyte}/I_{ref}=exp(−αΓLC) (1)

where T is the transmittance, I_{analyte} is the intensity of an optical signal under the presence of analyte, I_{ref} is the intensity of a reference signal, α is the absorption coefficient of the analyte, L is the physical waveguide length used for sensing and C is the concentration of analyte. Reflecting on Equation (1) above, a larger external confinement factor Γ will induce higher sensitivity of the SWG metamaterial waveguide sensor 800.

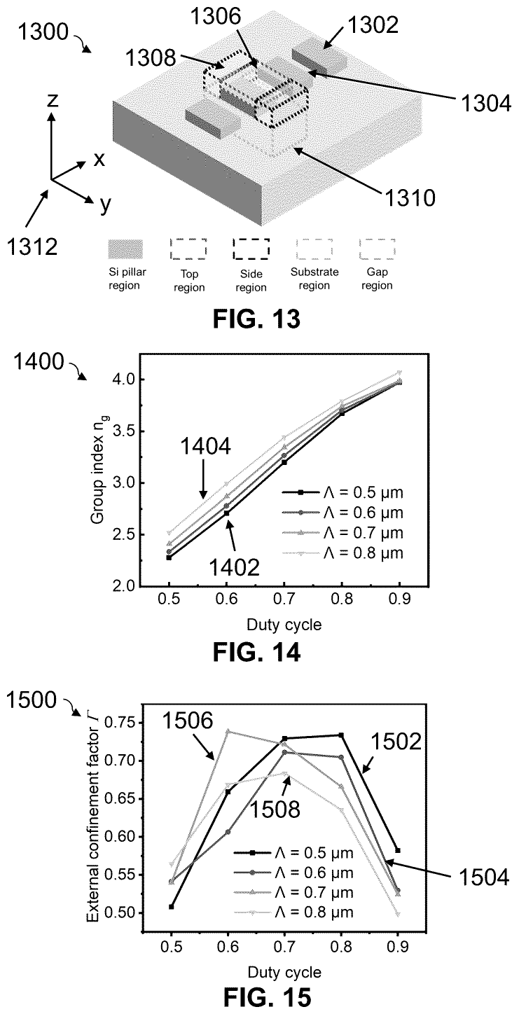

Detailed information on external confinement factor simulation and the relationship of the external confinement factor Γ with respect to the ∧ and DC is provided in relation to FIGS. 13 to 15.

FIG. 13 shows a schematic of a simulation model 1300 for use in simulating the square of electric field magnitude |E|² in respective regions of the SWG metamaterial waveguide 802 in accordance with an embodiment. The simulation model 1300 includes a Si pillar region 1302, and an air gap region 1304. Also shown in the simulation model 1300 are: a top air region 1306 at a top of the Si pillar region 1302 and the air gap region 1304, a side air region 1308 at a side and adjacent to the Si pillar region 1302 and the air gap region 1304, and a substrate region 1310 below the Si pillar region 1302 and the air gap region 1304.

Based on perturbation theory, external confinement factor Γ can be expressed by Equation 2 as shown below:

$$Γ = \frac{{d}_{{n}_{eff}}}{{d}_{{n}_{clad}}} = \frac{{n}_{g}}{{n}_{clad}} \frac{\int \int {\int }_{clad} ε {\vert E \vert}^{2} dxdydz}{\int \int {\int }_{- ∞}^{+ ∞} ε {\vert E \vert}^{2} dxdydz} \qquad ( 2 )$$

where the cladding refers to the air in our case (n_{clad}=nₐᵢᵣ=1), ε(x, y, z) is the permittivity in space and E(x, y, z) denotes the electric field distribution. In order to obtain the external confinement factor Γ, the 3D FDTD simulation was performed to calculate the integral term, using the simulation model as shown in relation to FIG. 13. Six monitors (1 monitor in the Si pillar region 1302, 1 monitor in the air gap region 1304, 1 monitor in the top air region 1306, 2 monitors in the left-side and right-side air regions 1308, 1 monitor in SiO₂ substrate region 1310) were placed in one subwavelength grating (SWG) metamaterial unit to extract the integral of |E|² in the corresponding region. The mesh size in the x-direction (c.f. the Cartesian axes 1312) was set as 0.1×period×(1-duty cycle). In the y- and z-directions, the mesh size was set as 75 nm and 50 nm. With this, Equation 2 is simplified to Equation 3 as shown below:

$${Γ}_{in air} = {n}_{g} \frac{{S}_{gap} + {S}_{top} + 2 {S}_{side}}{{S}_{gap} + {S}_{top} + 2 {S}_{side} + {ε}_{r , Si} {S}_{Si pillar} + {ε}_{r , {SiO}_{2}} {S}_{substrate}} \qquad ( 3 )$$

where the S represents the sum of |E| 2 from all pixels in the specific region, while ε_{r,Si} and ε_{r,SiO}_{₂} are equal to 11.736 and 1.952 at 3.77 μm, respectively.

FIG. 14 shows a graph 1400 of simulated group index n_{g} as a function of the period ∧ and duty cycle of the SWG metamaterial waveguide using the simulation model of FIG. 13 in accordance with an embodiment. Similar to the effective index n_{eff}, the group index n_{g} increases with increasing duty cycle and increasing period ∧. For example, a plot 1402 is shown for a period ∧ of 0.5 μm while a plot 1404 is shown for a period ∧ of 0.8 μm.

By substituting the simulated n g as shown in FIG. 14 into Equation 3 above, the external Γ for different period ∧ and duty cycle of the SWG metamaterial waveguide can be calculated. FIG. 15 shows a graph 1500 of calculated external confinement factor Γ with respect to the period ∧ and duty cycle of the SWG metamaterial waveguide using the simulation model of FIG. 13 in accordance with an embodiment. The plots 1502, 1504, 1506, 1508 show results for the calculated external confinement factor Γ with respect to a period ∧ of 0.5 μm, 0.6 μm, 0.7 μm and 0.8 μm, respectively.

The simulated wavelength of the input MIR light was at 3.77 μm and the SWG metamaterial waveguide has a period of 0.8 μm and a duty cycle of 0.8 with the external confinement factor Γ being 63.6%. Compared with a conventional strip waveguide having the same width and thickness (Γₛₜᵣᵢₚ=8.75%), the SWG metamaterial waveguide offers greater Γ within the designed range. Considering the lithographic accuracy, fabrication tolerance and propagation loss, a period ∧ of 0.8 μm and a duty cycle DC of 0.8 were selected in the present embodiment for fabricating the SWG metamaterial waveguide.

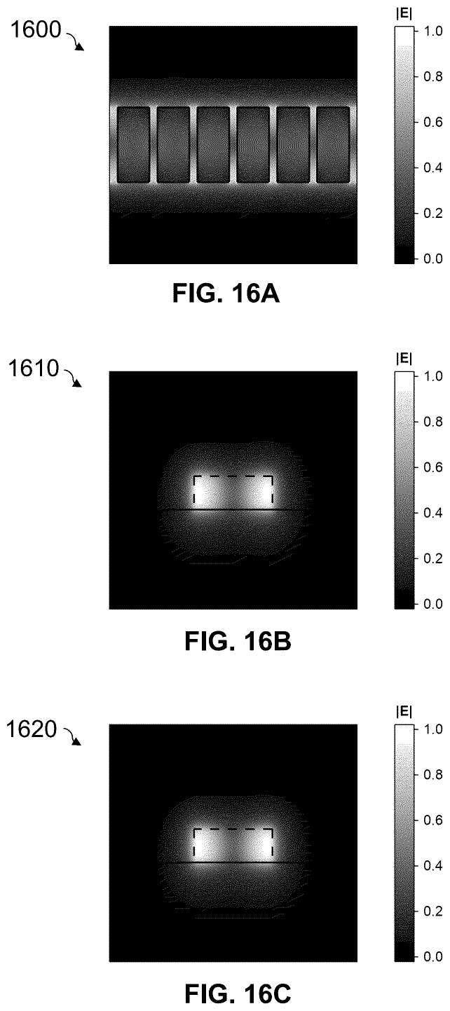

Electric field magnitude distribution of the selected SWG metamaterial structure was simulated to reveal the origin of the sensitivity improvement, as illustrated in relation to FIGS. 16A to 18 below.

FIGS. 16A, 16B and 16C show simulated distributions of electric field magnitude of a SWG metamaterial waveguide using the simulation model of FIG. 13 in accordance with an embodiment, where FIG. 16A shows a simulated distribution 1600 of electric field magnitude for the X-Y cross-section, FIG. 16B shows a simulated distribution 1610 of electric field magnitude for the Y-Z cross-section in the gap region and FIG. 16C shows a simulated distribution 1620 of electric field magnitude for the Y-Z cross-section in the Si pillar region 1302. The period ∧ and the duty cycle DC of the SWG metamaterial in the simulation were set as 0.8 μm and 0.8, respectively, to be consistent with the selected SWG metamaterial waveguide structure.

As shown in the simulated distributions 1600, 1610, 1620 of electric field magnitude, a strong electric field appears in air gap regions between the Si pillar regions 1302. These air gap regions are beneficial for enhanced light-matter interaction, resulting in the improved sensitivity of the SWG metamaterial waveguide sensor over conventional sensor (e.g., a conventional strip waveguide sensor).

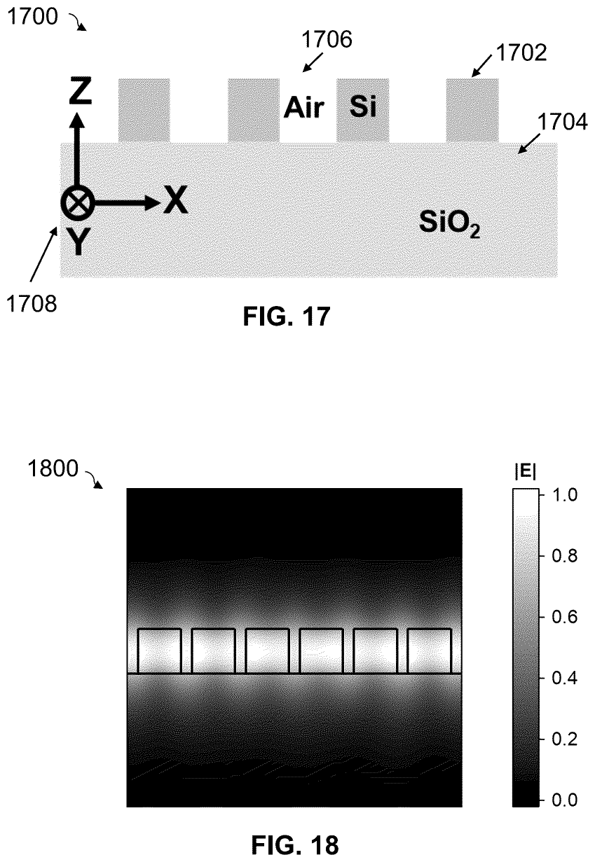

FIG. 17 shows a schematic of a planar side view 1700 of the SWG metamaterial waveguide of FIG. 10 in accordance with an embodiment. As shown in FIG. 17, Si pillars 1702 were formed on a SiO₂ layer 1704 and were spaced from one another by air gaps 1706. The Cartesian axes 1708 (i.e., x, y and z axes) are also shown which indicate that the planar side view 1700 is a X-Z cross-sectional plane view.

FIG. 18 show a simulated distribution 1800 of electric field magnitude of a SWG metamaterial waveguide using the simulation model of FIG. 13 in the X-Z cross-section in accordance with an embodiment. Consistent with the simulated distributions 1600, 1610, 1620 of electric field magnitude as shown in relation to FIGS. 16A to 16C, strong electric field appears in the air gaps 1706.

A reason for the high electric field appearing in the air gap is as follows. According to the boundary conditions from Maxwell's equation, a normal component of an electric displacement field (Dₓ) is continuous on an interface (e.g., for a perfect dielectric case). However, with the difference in permittivity of Si and air (ε_{Si}=11.736ε₀, εₐᵢᵣ=ε₀), the continuity of the electric displacement field induces a discontinuity of the electric field in the normal direction of the interface, where the ratio of the normal component of the electric field on the two sides of the interface, E_{x,Si}/E_{x,air}, is inversely proportional to the ratio of the permittivity of Si and air. Hence, a strong electric field can be found in the air gap regions, especially in the regions where Eₓ dominates the intensity of the electric field.

### Real-Time Monitoring of Analytes and Absorption Spectra Measurement

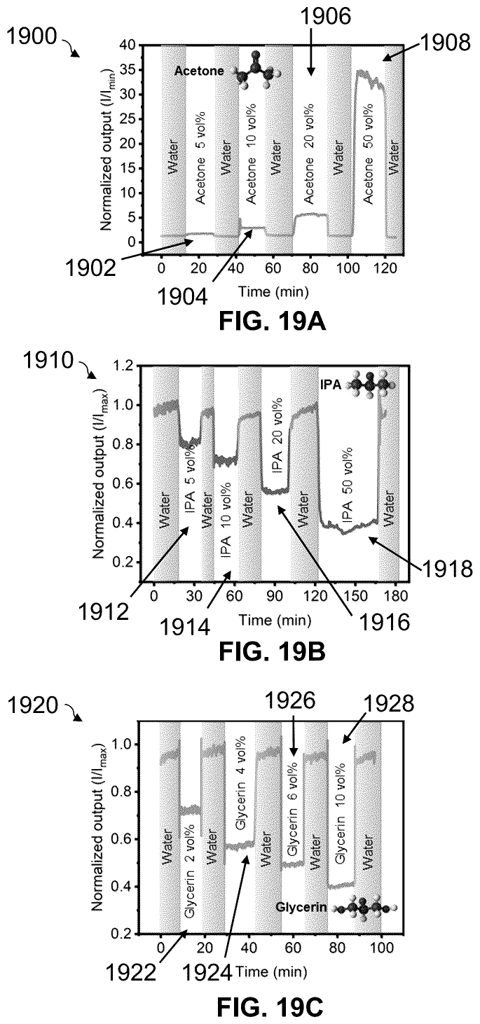

Before measuring absorption spectra for mixtures, dynamics monitoring of different solutes in water was performed to characterize the SWG metamaterial waveguide sensor 800. Acetone, IPA and glycerin were chosen as the measurand and also the constituents of mixtures in the present embodiments. Real-time monitoring of the SWG metamaterial waveguide sensor 800 for acetone, isopropyl alcohol (IPA) and glycerin solutions of different concentrations are shown below in relation to FIGS. 19A, 19B and 19C, respectively.

FIGS. 19A, 19B and 19C show graphs of normalized output versus time to illustrate dynamic monitoring of different components in a mixture in accordance with an embodiment.

FIG. 19A shows a graph 1900 of normalized output versus time to illustrate dynamic monitoring of acetone. Different concentrations of acetone solution were used and these acetone solutions were introduced with spacing by a period of pure water injection to reset the condition within the PDMS chamber 804. As shown in the graph 1900, a 5 vol % acetone solution 1902, a 10 vol % acetone solution 1904, a 20 vol % acetone solution 1906 and a 50 vol % acetone solution 1908 were used in the present case and were injected at different times.

FIG. 19B shows a graph 1910 of normalized output versus time to illustrate dynamic monitoring of IPA. Similar to the measurements performed using the acetone solutions above, introductions of these different IPA solutions were spaced by a period of pure water injection to reset the condition within the PDMS chamber 804. As shown in the graph 1910, a 5 vol % IPA solution 1912, a 10 vol % IPA solution 1914, a 20 vol % IPA solution 1916 and a 50 vol % IPA solution 1918 were used in the present case and were injected at different times.

FIG. 19C shows a graph 1920 of normalized output versus time to illustrate dynamic monitoring of glycerin. Similarly, in this case, introductions of these different glycerin solutions were spaced by a period of pure water injection to reset the condition within the PDMS chamber 804. A 2 vol % glycerin solution 1922, a 4 vol % glycerin solution 1924, a 6 vol % glycerin solution 1926 and a 10 vol % glycerin solution 1928 were used in the present case and were injected at different times as shown in the graph 1920.

The time traces as shown in relation to the graphs 1900, 1910 and 1920 above reveal changes in optical transmissions caused by changes in the analyte concentrations for all three analytes. The small spikes shown in the graphs 1900, 1910 and 1920 during transitions were caused by the introduction of air when switching solutions.

Using the real-time monitoring results as shown in relation to FIGS. 19A to 19C, absorbance differences (Δ Absorbance) between pure water and binary solutions versus the analyte concentration were plotted, where the absorbance difference is given by: Δ Absorbance=−(α_{analyte}−α_{water})ΓLC_{analyte}×log₁₀e=log(I_{analyte}/I_{water}).

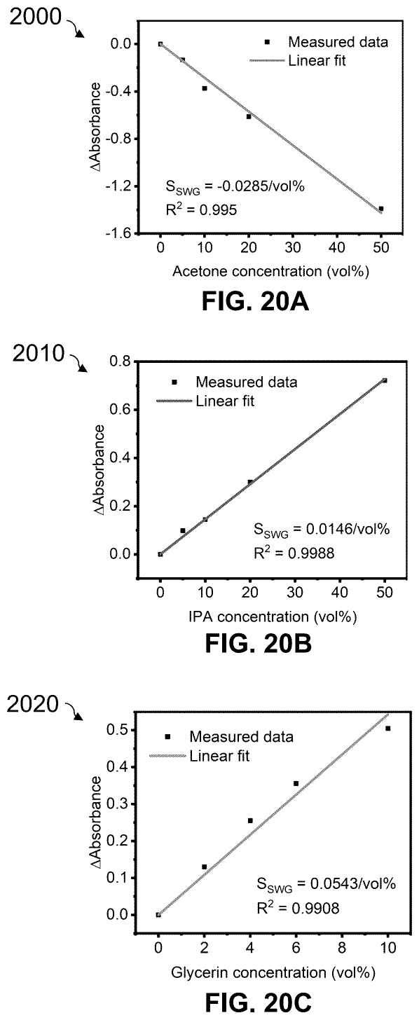

FIGS. 20A, 20B and 20C show graphs of absorbance difference (Δ Absorbance) between water and various analytes versus analyte concentrations for a plurality of mixtures in accordance with embodiments. FIG. 20A shows a graph 2000 of absorbance difference (Δ Absorbance) between water and acetone versus acetone concentration, FIG. 20B shows a graph 2010 of absorbance difference (Δ Absorbance) between water and IPA versus IPA concentration, and FIG. 20C shows a graph 2020 of absorbance difference (Δ Absorbance) between water and glycerin versus glycerin concentration.

As shown in relation to the graphs 2000, 2010, 2020, all R-squares values for the linear fittings of the three analytes are larger than 0.99, exhibiting a good linear response of the SWG metamaterial waveguide sensor 800 for sensing these analytes. The sensitivity of the SWG metamaterial waveguide sensor 800 was extracted from the slope of these linear plots and are −0.0285 per vol %, 0.0146 per vol %, and 0.0543 per vol % for acetone, IPA and glycerin, respectively. The negative sensitivity obtained from the linear plot of acetone represents a lower absorbance of acetone compared to water. Further, a strip waveguide sensor without a SWG metamaterial structure was fabricated as a control on the same chip and similar acetone real-time monitoring was performed for this strip waveguide sensor for comparison.

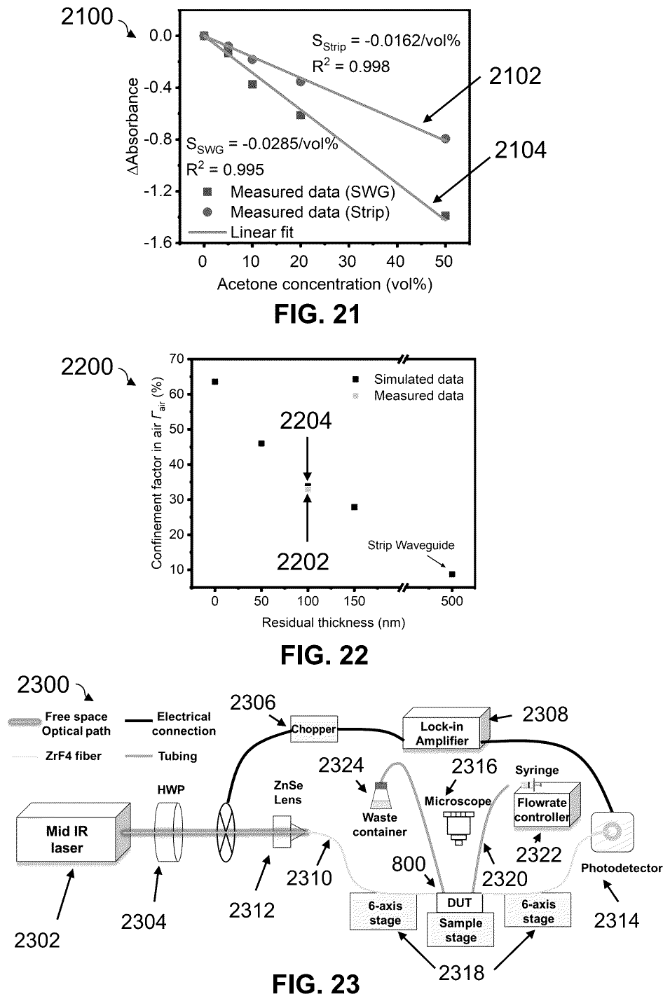

FIG. 21 shows a graph 2100 of absorbance difference (Δ Absorbance) between water and acetone versus acetone concentration for the strip waveguide sensor and the SWG metamaterial waveguide sensor 800 in accordance with an embodiment. A linear fitting 2102 for the strip waveguide sensor and a linear fitting 2104 for the SWG metamaterial waveguide sensor 800 were shown. The sensitivities of the strip waveguide sensor and the SWG metamaterial waveguide sensor for acetone were extracted from the slope of their corresponding linear plots and they are −0.0162 per vol % and −0.0285 per vol %, respectively. Therefore, with an equal sensing length of 2 mm, substitution of only 660 μm of a strip waveguide by a SWG metamaterial structure brings about an enhanced sensitivity by 1.76 times, which corresponds to an external confinement factor for the SWG metamaterial structure Γ_{SWG} of 32.52%.

The deviation of Γ_{SWG} between the simulation and the actual physical device may be due to incomplete etching between the Si pillars formed in the physical SWG metamaterial waveguide sensor 800. Referring back to the discussion in relation to FIGS. 13 to 15, the simulated Γ of the SWG metamaterial structure with a period of 0.8 μm and a duty cycle of 0.8 is 63.58%, while the empirical value obtained was 32.52%. A probable reason for this phenomenon could be in relation to incomplete etching in the air gap regions of the SWG metamaterial structure, which may come from the loading effect during etching. By using a similar simulation method as previously described in relation to FIGS. 13 to 15, the relationship between the Γ and the residual thickness can be simulated and this is shown in FIG. 22.

FIG. 22 shows a graph 2200 of simulated confinement factor in air versus a thickness of silicon residual between silicon pillars of the SWG metamaterial waveguide in accordance with an embodiment. The simulation was operated at the wavelength of 3.77 μm.

With an increasing level of incomplete etching, the external confinement factor Γ keeps going down to 8.75% and become similar to the external confinement factor of a strip waveguide. At the point with a residual thickness of 100 nm, the experimental value 2202 shows a good agreement with the simulation result 2204. It can therefore be inferred that there still exists around 100 nm thick of Si to be etched away in the air gap regions. A SWG metamaterial waveguide having a higher Γ can be achieved by applying a longer etching time or optimizing an etching recipe. Nevertheless, the external confinement factor Γ of the SWG metamaterial waveguide of the present embodiments still show nearly four times to that of the conventional strip waveguide. The fabricated SWG metamaterial waveguide sensor 800 therefore still significantly outperforms the conventional strip waveguide sensor in sensitivity without using more complex fabrication methods and provides a feasible and simple way to attain higher sensitivity in compact footprints.

FIG. 23 shows a schematic diagram of a testing setup 2300 for measuring absorption spectra of different mixtures with varying analyte concentrations in accordance with an embodiment.

For the testing setup 2300, a quantum cascaded laser 2302 was used as the light source for providing the MIR light input. The polarization of the light was controlled by a low-order half-wave plate 2304 placed at the output of the laser 2302. An optical chopper 2306 put behind the half-wave plate 2304 was connected to a lock-in amplifier 2308. The output of the laser 2302 was further coupled to a MIR ZrF4 fiber 2310 using a ZnSe lens 2312. Two on-chip grating couplers (not shown) were responsible for the light coupling between the SWG metamaterial waveguide sensor 800 and the MIR ZrF4 fiber 2310, and the output signal from the SWG metamaterial waveguide sensor 800 was transmitted to the photodetector 2314 which was also connected to the lock-in amplifier 2308. Through the observation from an optical microscope 2316, the location of the two MIR ZrF4 fibers 2310 can be fine-tuned using two 6-axis stages 2318 for accurate alignment between the MIR ZrF4 fibers 2310 and the grating couplers. Regarding liquid flow control, a liquid analyte (or a target mixture) can be provided in a syringe and injected into the PDMS chamber 804 of the SWG metamaterial waveguide sensor 800 through polyethylene (PE) tubing 2320, and the flow rate of the liquid analyte can be adjusted by a flow rate controller 2322 where the syringe was installed. The liquid analyte flowing out from the PDMS chamber 804 would eventually be discharged into a waste container 2324. For measuring an absorption spectrum of a liquid analyte or mixture, output signals for different input laser wavelengths were recorded by the lock-in amplifier 2308 along with the tuning of the output wavelength of the laser 2302. The time constant of the lock-in amplifier 2308 was set as 300 ms which can be increased for smaller noise levels.

The following liquid mixtures were prepared for the present experiment and analysis. With four concentrations given by each solute, i.e., acetone and IPA each having concentrations of 0 vol %, 5 vol %, 10 vol % and 15 vol %, and glycerin having concentrations of 0 vol %, 2 vol %, 4 vol % and 6 vol %. By mixing these solutes with one another, a ternary mixture with sixty-four mixing ratios in water can be obtained.

The testing setup 2300 as shown in relation to FIG. 23 was used for the absorption spectra measurement. In the present embodiment, mixtures of different concentration combinations were provided in the PDMS chamber 804 of the SWG metamaterial waveguide sensor 800 one by one, with water acting as the buffer and was sent into the PDMS chamber 804 at every interval between injections of different mixtures. This is similar to the sequences shown in relation to FIGS. 19A to 19C above. Instead of recording an absorption intensity at a single wavelength which carries limited information of a substance, the absorption spectrum of each mixture solution, including the buffer solution infused at every interval, was collected by sweeping the output wavelength of the laser 2302 after the output signal received from the SWG metamaterial waveguide sensor 800 was stabilized. All absorption spectra were measured with a laser output wavelength ranging from 3.708 μm to 3.803 μm with a step of 1 nm. Besides, to eliminate various unknown and unstable factors in this dynamic measurement process, all absorption spectra measured for the various mixtures were normalized with the nearest buffer solution spectrum, which is the water spectrum recorded for the nearest interval. At the end of this measurement process, absorption spectra for sixty-four classes corresponding to sixty-four different mixing ratios or component concentration combinations of mixtures were acquired.

### Convolution Neural Network for Recognition of Mixture Absorption Spectrum

Without loss of generality, twelve normalized absorption spectra measured for these sixty-four classes of mixtures were plotted. This is shown in relation to FIG. 24. These absorption spectra formed part of the training absorption spectra for used in training a first machine learning model, which in this embodiment, includes a CNN.

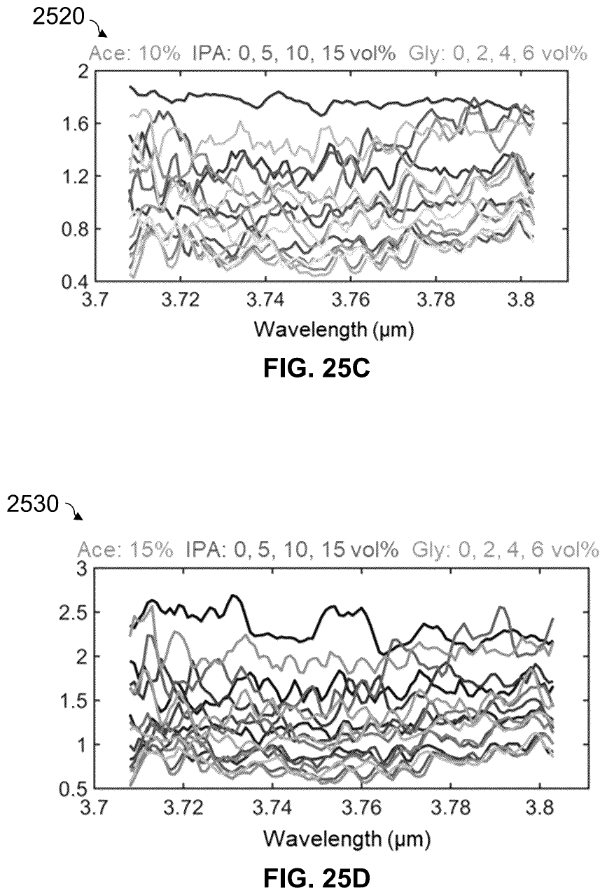

FIG. 24 shows a graph 2400 of normalized signal versus wavelength of a portion of the training absorption spectra used in training a first machine learning model in accordance with an embodiment. As shown in the graph 2400, although there are differences between various absorption spectra, some absorption spectra appear to be less distinguishable from one another. This complication is worse if all sixty-four absorption spectra. This is shown in relation to FIGS. 25A to 25D below.

FIGS. 25A, 25B, 25C and 25D show graphs of normalized signal versus wavelength of the training absorption spectra for mixtures of sixty-four concentration combinations as used for the training of the first machine learning model in accordance with an embodiment.

FIG. 25A shows a graph 2500 of normalized signal versus laser output wavelength for mixtures having 0 vol % of acetone and with varying concentrations of IPA (0 vol %, 5 vol %, 10 vol % and 15 vol %) and glycerin (0 vol %, 2 vol %, 4 vol % and 6 vol %). FIG. 25B shows a graph 2510 of normalized signal versus laser output wavelength for mixtures having 5 vol % of acetone and with varying concentrations of IPA (0 vol %, 5 vol %, 10 vol % and 15 vol %) and glycerin (0 vol %, 2 vol %, 4 vol % and 6 vol %). FIG. 25C shows a graph 2520 of normalized signal versus laser output wavelength for mixtures having 10 vol % of acetone and with varying concentrations of IPA (0 vol %, 5 vol %, 10 vol % and 15 vol %) and glycerin (0 vol %, 2 vol %, 4 vol % and 6 vol %). FIG. 25D shows a graph 2530 of normalized signal versus laser output wavelength for mixtures having 15 vol % of acetone and with varying concentrations of IPA (0 vol %, 5 vol %, 10 vol % and 15 vol %) and glycerin (0 vol %, 2 vol %, 4 vol % and 6 vol %).

Each graph 2500, 2510, 2520, 2530 includes sixteen absorption spectra, corresponding to 16 concentration combinations of IPA and glycerin at fixed concentrations of acetone (i.e., 0 vol %, 5 vol %, 10 vol % and 15 vol %). The sixty-four mixing ratios or component concentration combinations correspond to the sixty-four labels as presented in relation to FIG. 27 below, where the graph 2500 shows the sixteen absorption spectra for the labels 1 to 16, the graph 2510 shows the sixteen absorption spectra for the labels 17 to 32, the graph 2520 shows the sixteen absorption spectra for the labels 33 to 48 and the graph 2530 shows the sixteen absorption spectra for the labels 49 to 64.

Further complicating the analysis of these absorption spectra is that the present analytes or components of the mixtures include an analyte having an absorbance higher than water (i.e., acetone) and analytes having absorbance lower than water (i.e. IPA and glycerin). Potential cancellation of the absorption effects of these analytes coexisting in a same mixture increases the difficulty in analyzing these absorption spectra.

In the present embodiment, a CNN machine learning model was used to differentiate and classify the absorption spectra obtained for these sixty-four different component concentration combinations. Machine learning has shown impressive capabilities in tasks of feature extraction and object identification. Particularly, CNN excels at classification problems and is appropriate for the present embodiment.

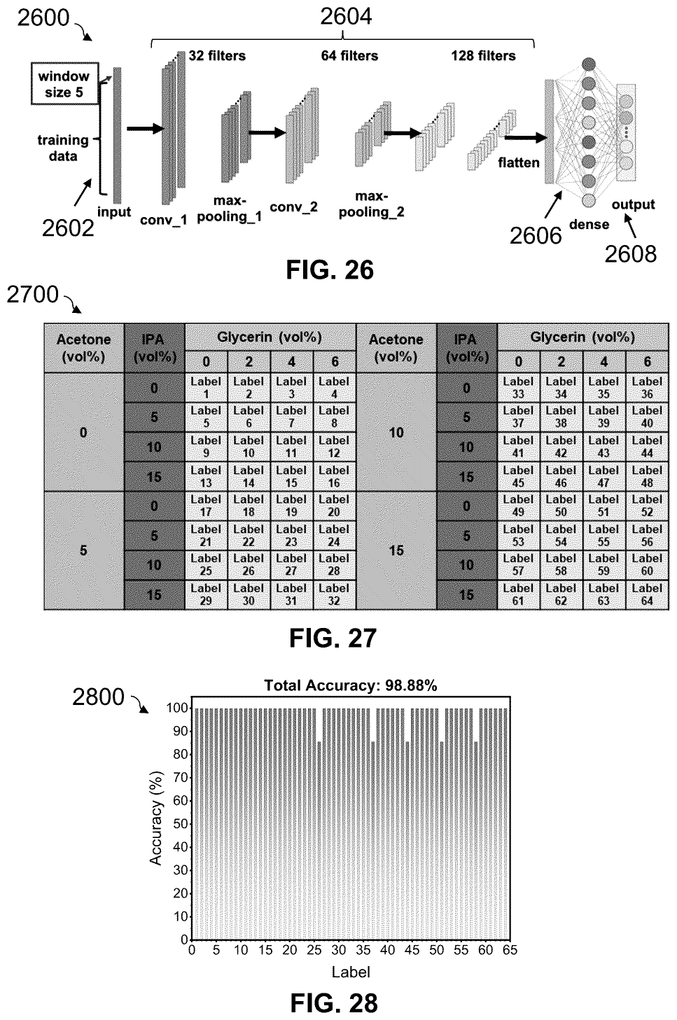

For the present embodiment, twenty-one almost consistent absorption spectra were recorded for each component concentration combination (i.e., each mixture class). A total number of 64×21 absorption spectra were therefore recorded for these sixty-four mixing component concentration combinations, and these were prepared for building a dataset which was fed into the CNN model for the subsequent training and testing processes. In the present embodiment, fourteen of the twenty-one absorption spectra for each mixture was used for training and seven of the twenty-one absorption spectra for each mixture was used for testing, resulting in the training dataset and test dataset with dimensions of 14×64 and 7×64, respectively. In the present embodiment, a one-dimensional CNN (1D-CNN) structure was leveraged to perform the mixture classification and the detailed structure of the 1D-CNN is illustrated in relation to FIG. 26.

FIG. 26 is a schematic structure 2600 of a first machine learning model, a convolutional neural network (CNN), used in the computer-implemented method 500 for determining predicted component concentrations of a target mixture in accordance with an embodiment. As shown in the structure 2600 of the CNN model, training data can be provided via an input layer 2602 which was then filtered through convolutional layers and pooling layers 2604 before being processed using the fully connected layers 2606 to classify an absorption spectrum into one of the sixty-four classes/labels at the output 2608 in the present embodiment.

In the present embodiment, the CNN model employed was constructed as follows: the categorical cross-entropy function was adopted as the loss function, and the adaptive moment estimation (Adam) was utilized as the optimizer. The CNN model was developed in Python with a Keras and TensorFlow backend.

FIG. 27 is a comparison table 2700 for labeling mixtures having different mixing ratios for use with the CNN model of FIG. 26 in accordance with an embodiment. For example, Label 42 corresponds to a mixture having 10 vol % acetone, 10 vol % IPA and 2 vol % glycerin in water. By following a one-to-one correspondence between the sixty-four mixing ratios and the labels 1 to 64 as shown in the table 2700, an input absorption spectrum of a mixture (e.g. a target mixture) can be classified into a specific label (i.e. 1 out of the 64 mixing labels) to determine the component concentrations of this mixture.

FIG. 28 shows a bar chart 2800 of testing accuracy for a test dataset using the CNN model for the sixty-four labelled mixtures of FIG. 27 in accordance with an embodiment. As shown in the bar chart 2800, an accuracy of 98.88% in classifying these 64 classes of mixture absorption spectra was realized.

In addition to the 64-class mixture classification, possibility of distinguishing concentrations lower than the limit of detection (LoD) of these analytes was also investigated using the CNN machine learning model.

As an example, for the present glycerin sensing, the Beer-Lambert's law is shown in Equation 4 below:

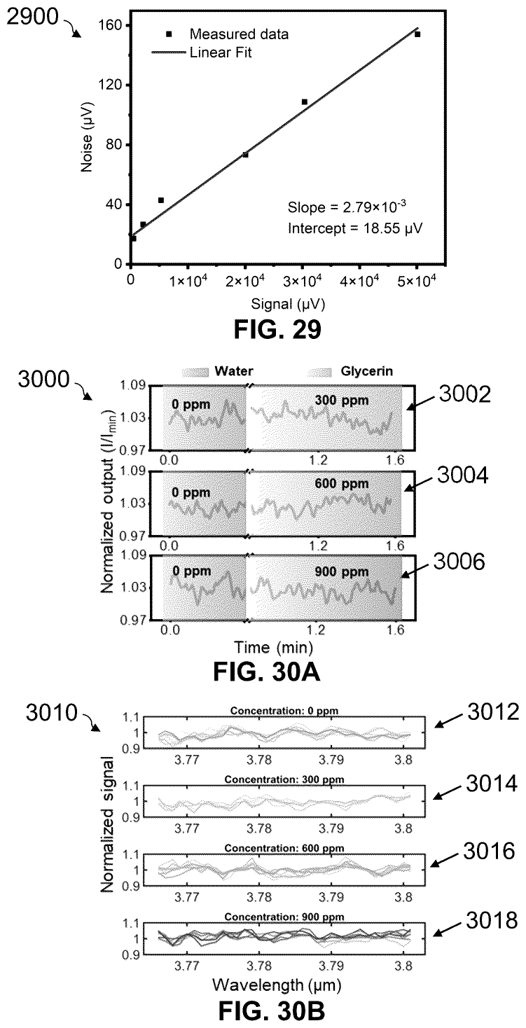

T=I_{glycerin}/I_{water}=exp(−ΔαΓLC) (4)

where the Δα is the difference in absorption coefficient between glycerin and water. Further, the equation for calculating the LoD of glycerin based on 3-Sigma rule can be expressed as:

$$\frac{{I}_{water} ( 1 - exp ( - ΔαΓ {LC}_{LoD} ) )}{{I}_{noise}} \qquad ( 5 )$$

where the C_{LoD} is the LoD of glycerin. Generally, noise characterization of MIR waveguide sensor can be classed into two cases for analysis: (i) Iₙₒᵢₛₑ=constant, which mainly comes from the photodetector or (ii) Iₙₒᵢₛₑ=kI+C, where the noise floor mainly originated from the laser power fluctuation and is linearly related to the signal intensity. The noise measurement of the present sensing system is shown in relation to FIG. 29 below.

FIG. 29 shows a graph 2900 of noise (μV) as a function of signal intensity (μV) for calculating the limit of detection (LoD) of glycerin in accordance with an embodiment. The time constant of the lock-in amplifier 2308 was set as 300 ms and the chopping frequency of the chopper 2306 was set as 360 Hz.

A clear linear fitting result is shown in the graph 2900 which suggests that the noise in our measurement range belonged to the second case, i.e., the noise is proportional to the signal intensity. The typical value of I_{water} (reference signal) in the measurement was ˜15 mV. Based on the linear fitting equation: Iₙₒᵢₛₑ=0.00279I_{signal}+18.55, this reference signal produces a noise floor of 60.4 μV. The slope of the linear fitting plot indicates a laser power fluctuation equal to 0.279% of the signal intensity, and the intercept value represents a constant photodetector noise of around 18.55 μV.

The term of ΔαΓL in Equation 5 represents the sensitivity of the SWG metamaterial waveguide sensor 800 and can be extracted from the experimental result in relation to FIG. 20C. Substituting the calculated noise floor and

$$ΔαΓ L = \frac{0.0543 / vol \%}{{log}_{{10}^{e}}}$$

due to the base-10 logarithm used in absorbance while the natural logarithm is used in Beer-Lambert's law) into Equation 5, C_{LoD} (i.e. the LoD concentration value of glycerin) of 972 ppm can be obtained for glycerin detection based on the 3-Sigma rule.

Based on this LoD value, glycerin solutions with concentrations ranging from 0 to 900 ppm with increments of 300 ppm were prepared and their absorption spectra were measured in a similar manner using the setup 2300.

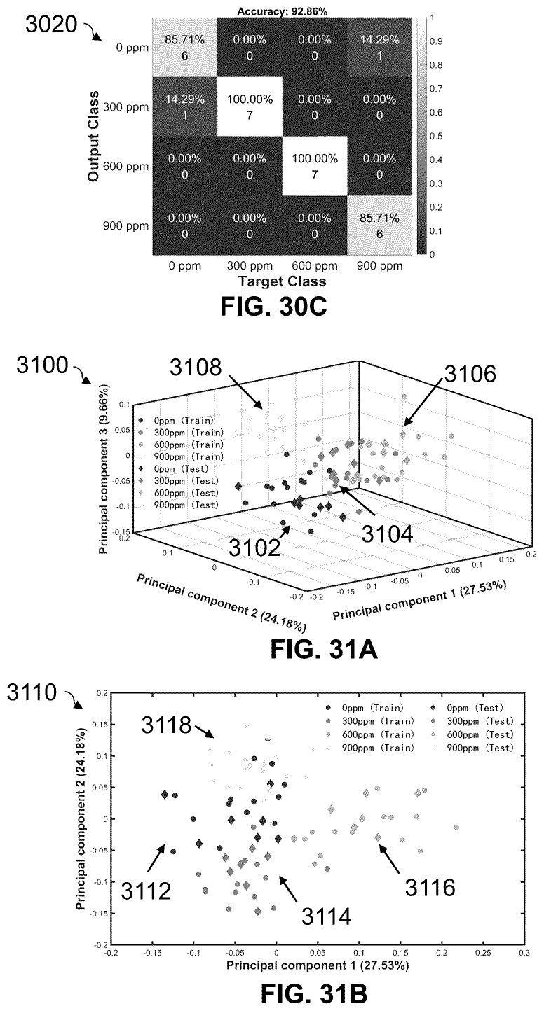

FIGS. 30A, 30B and 30C show empirical results in relation to distinguishing four concentrations of glycerin lower than the LoD in accordance with an embodiment.

FIG. 30A shows graphs 3002, 3004, 3006 of normalized output versus time to illustrate monitoring of a liquid switching process from water to 300 ppm, 600 ppm and 900 ppm glycerin solution at a laser output wavelength of 3.77 μm. As shown in these graphs 3002, 3004, 3006, there is no clear intensity change during the liquid switching process as expected.

In addition to real-time monitoring as shown in relation to FIG. 30A, absorption spectra measured using different glycerin concentrations were also recorded with twenty-one consistent absorption spectra recorded for each glycerin concentration. Following the previous splitting ratio for the division of training and test dataset, a total of 7×4 absorption spectra were included in a test dataset.

FIG. 30B shows graphs 3012, 3014, 3016, 3018 of normalized absorption spectra of water (i.e., 0 ppm of glycerin), 300 ppm, 600 ppm and 900 ppm glycerin solutions, respectively. As all these absorption spectra were normalized with the water background in a similar manner as previously discussed, the absorption spectra as shown in the graphs 3012, 3014, 3016, 3018 were all around a straight line close to a value of 1 without significant discernible features.

FIG. 30C shows a confusion matrix 3020 for the 7×4 testing absorption spectra for recognizing the four trace glycerin concentrations as described above. As shown in the confusion matrix 3020, there were only two misclassifications, with the CNN model achieving a 92.86% classification accuracy for differentiating the different glycerin solutions with concentrations lower than the LoD. This further demonstrates the ability of the present CNN model used in unearthing subtle or concealed features in absorption spectra of mixtures and its applicability for detecting trace amount of gas or liquid.

To confirm the presence of hidden features that may be helpful for classifying absorption spectra, principal component analysis (PCA) was applied to the spectrum data for feature extraction and dimension reduction.

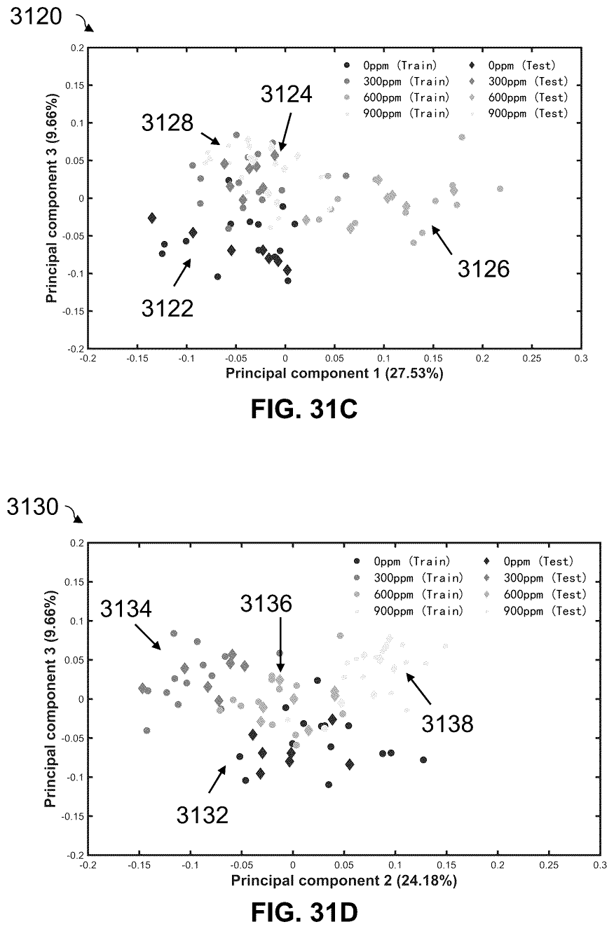

FIGS. 31A, 31B, 31C and 31D show visualizations of principal component analysis (PCA) results of the absorption spectra measured for the four trace glycerin concentrations of 0 ppm, 300 ppm, 600 ppm and 900 ppm glycerin solutions in accordance with an embodiment. Each point in these visualizations represents one spectrum, with circles representing training absorption spectra and diamonds representing testing absorption spectra. The points with a similar shade form a cluster and represent a group of absorption spectra with the same glycerin concentration. The visualization results for a total of eighty-four absorption spectra after PCA processing are shown in FIGS. 31A to 31D.

FIG. 31A shows a visualization 3100 of the analyzed spectra projected in three-dimensional (3D) principal components (PC) space where absorption spectra data points 3102 for a glycerin concentration of 0 ppm, absorption spectra data points 3104 for a glycerin concentration of 300 ppm, absorption spectra data points 3106 for a glycerin concentration of 600 ppm and the absorption spectra data points 3108 for a glycerin concentration of 900 ppm are shown.

As shown in the visualization 3100, four clusters 3102, 3104, 3106, 3108 with distinguishable boundaries corresponding to the four glycerin concentrations can be observed in the 3D principal components space. This shows that there exist distinguishable features in absorption spectra for glycerin solutions with a glycerin concentration lower than the LoD.

FIG. 31B shows a visualization 3110 of the analyzed absorption spectra projected in the PC1-PC2 plane, FIG. 31C shows a visualization 3120 of the analyzed absorption spectra projected in the PC1-PC3 plane, and FIG. 31D shows a visualization 3130 of the analyzed absorption spectra projected in the PC2-PC3 plane. Absorption spectra data points 3112, 3122, 3132 for a glycerin concentration of 0 ppm, absorption spectra data points 3114, 3124, 3134 for a glycerin concentration of 300 ppm, absorption spectra data points 3116, 3126, 3136 for a glycerin concentration of 600 ppm and the absorption spectra data points 3118, 3128, 3138 for a glycerin concentration of 900 ppm are shown in each of these visualizations 3110, 3120, 3130.

Although there still exists an overlap between the different clusters in the 2D PC spaces, by using three principal components, a decision boundary can be found to roughly distinguish each cluster in the 3D PC space as shown in relation to FIG. 31A. For example, the cluster 3118 for a glycerin concentration of 900 ppm and the cluster 3112 for a glycerin concentration of 0 ppm which partially overlap in the PC1-PC2 space can be differentiated in the PC1-PC3 space (i.e., as shown in relation to FIG. 31C) or the PC2-PC3 space (i.e. as shown in relation to FIG. 31D). The PCA was performed using MATLAB_R2020b.

### Multi-Layer Perceptron Regressor for Spectrum Decomposition

Although use of the CNN model as presented above allow determination of component concentrations in a mixture with remarkable accuracy, individual spectrum information of each component with their corresponding concentrations, namely in relation to a pure form of each component, was not extracted.

In an embodiment, an MLP regressor model was used to implement spectrum decomposition for extracting component absorption spectra in relation to the pure forms of each component. In contrast to the CNN model which requires massive data for model learning (e.g., 21×64 absorption spectra in total as discussed above), the MLP regressor only needs one spectrum per component concentration combination (or mixing ratio) for training. By sweeping the input laser wavelength only one time for each component concentration combination of a mixture, 1×64 absorption spectra in total were recorded from additional measurements in the present embodiment for use with the MLP regressor model.

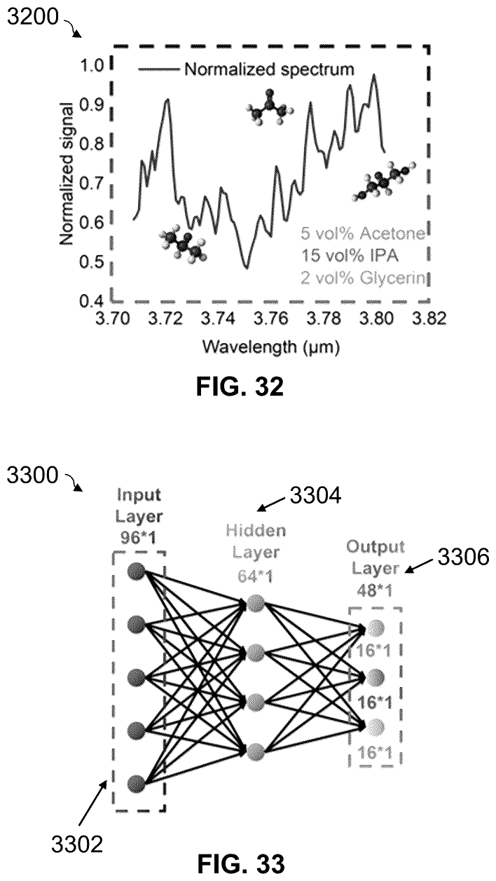

The operation flow of the MLP regressor for spectrum decomposition is illustrated in relation to FIGS. 32, 33 and 34A to 34C, using an exemplary mixture having 5 vol % acetone, 15 vol % IPA and 2 vol % glycerin in water solution.

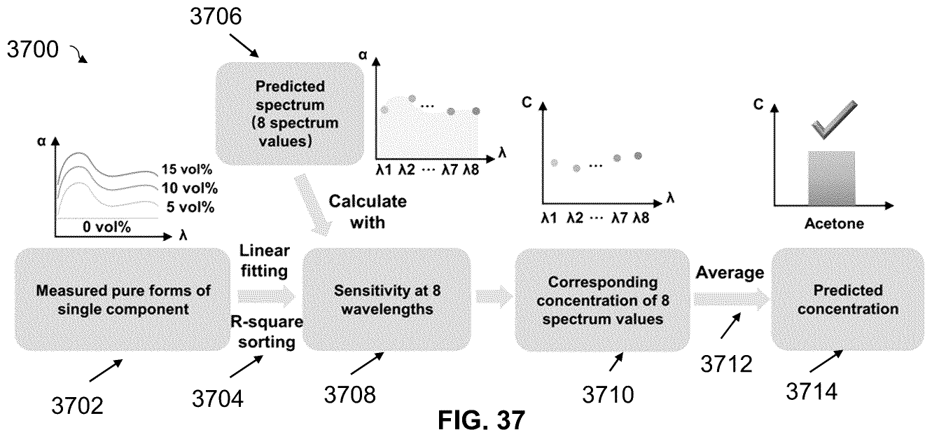

In the present embodiment, the programming framework of the MLP regressor used was based on PyTorch (version 1.12.0), a Python (version 3.7.13) computing package. The prediction of the component concentrations, which would be discussed subsequently in relation to FIGS. 37 to 42, was performed using MATLAB_R2020b.

FIG. 32 shows a normalized absorption spectrum 3200 of the exemplary mixture having 5 vol % acetone, 15 vol % IPA and 2 vol % glycerin in water solution as an input to the MLP regressor model in accordance with an embodiment. The normalized absorption spectrum 3200 includes 96 wavelength points ranging from 3.708 μm to 3.803 μm and this was sent into the MLP regressor input layer as shown in relation to FIG. 33.

FIG. 33 shows a structure 3300 of a three-layer MLP regressor model for decomposing an absorption spectrum into component absorption spectra in accordance with an embodiment. The structure 3300 includes an input layer 3302 having a dimension of 96×1, a hidden layer 3304 having a dimension of 64×1 and an output layer 3306 having a dimension of 48×1.

After being processed by the two-fully connected layers (i.e., 3302 to 3304, and 3304 to 3306), the absorption spectrum of the exemplary mixture was decomposed to an absorption spectrum for 5 vol % acetone, an absorption spectrum for 15 vol % IPA and an absorption spectrum for 2 vol % glycerin, each having 16 wavelength points as shown in the output layer 3306.

For the training process, 48 of 64 absorption spectra were randomly selected as the training dataset, and the ground truth (expected output) was set as the cascading of three target component absorption spectra. Each target component absorption spectrum has 16 identical wavelengths and was extracted from the measured pure form of each component, forming an output vector with a dimension of 48×1.

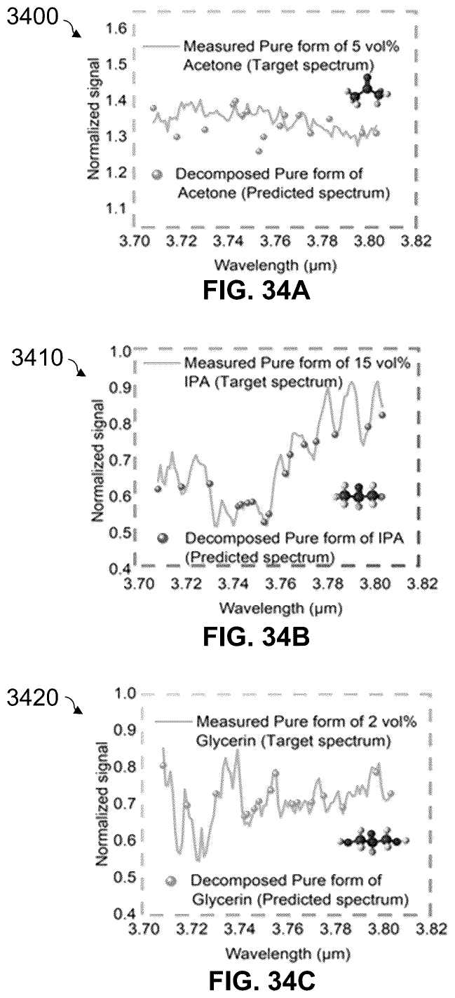

FIGS. 34A, 34B and 34C show graphs of normalized signal versus wavelength in relation to decomposed component absorption spectra of the exemplary mixture of FIG. 32 as output by the MLP regressor of FIG. 33.

FIG. 34A shows decomposed component absorption spectra data 3400 for acetone, FIG. 34B shows decomposed component absorption spectra data 3410 for IPA and FIG. 34C shows decomposed component absorption spectra data 3420 for glycerin.

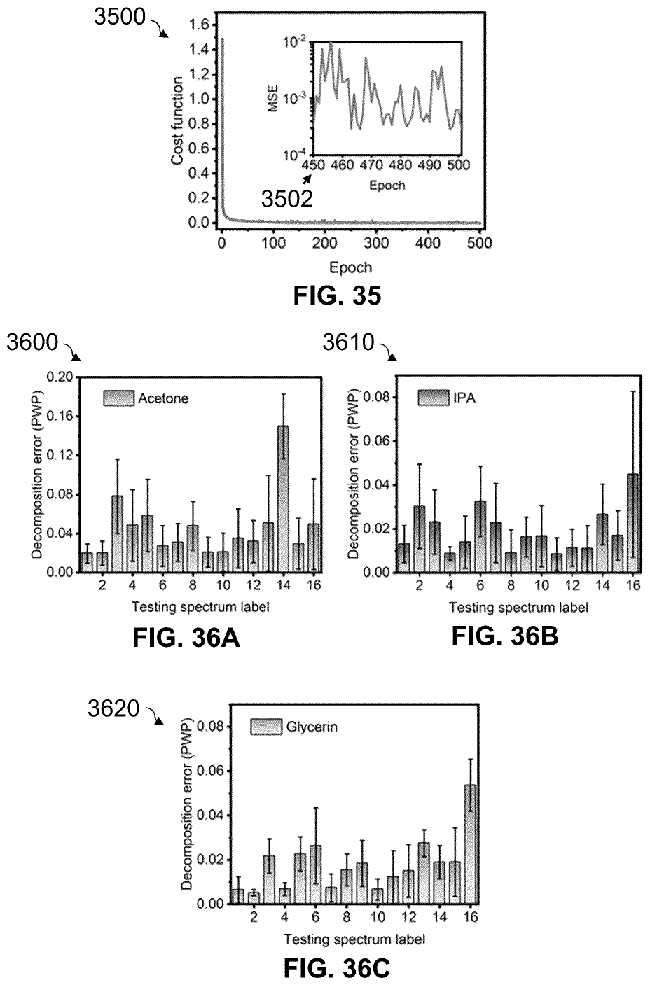

In terms of the cost function, i.e., mean squared error (MSE), which measures a deviation between the target absorption spectrum (i.e., measured pure form) and predicted absorption spectrum (i.e. decomposed pure form) was plotted as a function of the training epoch as shown in FIG. 35.

FIG. 35 shows a graph 3500 of mean squared error (MSE) as a function of training epoch in relation to the forty-eight absorption spectra for forty-eight mixtures of a training data set in accordance with an embodiment. An inset 3502 shows a zoom-in portion of the graph 3500 for an epoch value of 450 to 500.

As shown in the graph 3500, the MSE gradually decreases to around 5×10⁻³ by using the Root Mean Squared Propagation (RMSProp) Optimizer with a learning rate of 0.0005. Unlike the CNN model which has to experience all classes of data in the training process, the forty-eight mixture spectra in the training process of the MLP regressor included only a subset of all concentration combinations, which means the concentration combinations associated with the sixteen testing absorption spectra in the test dataset were completely unknown to the MLP regressor. In order to precisely characterize the testing result of these sixteen testing absorption spectra, a decomposition error using the unit of per wavelength point (PWP) was defined. The decomposition error describes an average single-point error between the predicted absorption spectrum and the target absorption spectrum. The single-point errors were all in absolute values before averaging. Using a trained MLP regressor which provides an output vector of a testing absorption spectrum containing the decomposed component absorption spectra of the three components, the testing results for all sixteen testing absorption spectra in the present embodiment are shown in relation to FIGS. 36A, 36B and 36C.

FIGS. 36A, 36B and 36C show graphs of decomposition error for sixteen component absorption spectra of a testing data set in accordance with an embodiment.

FIG. 36A shows a graph 3600 of decomposition error for sixteen acetone component absorption spectra, FIG. 36B shows a graph 3610 of decomposition error for sixteen IPA component absorption spectra and FIG. 36C shows a graph 3620 of decomposition error for sixteen glycerin component absorption spectra. The example absorption spectra as shown in relation to FIGS. 34A to 34C correspond to a testing spectrum label of 11 as shown in relation to FIGS. 36A, 36B and 36C. This corresponds to the decomposition error of 0.035, 0.008, and 0.012 for acetone, IPA, and glycerin, respectively.

Further, as shown in the graphs 3600, 3610, 3620, decomposition errors below 0.05 PWP were realized for most of the testing absorption spectra, and the average decomposition error for the 16 testing absorption spectra was around 0.027 PWP, suggesting a high decomposition accuracy. Additionally, a small deviation in pure form prediction also reflects a stability of the SWG metamaterial waveguide sensor 800 for liquid mixture sensing. The testing results of acetone show a larger decomposition error because of the wider variation range of its pure forms as compared with IPA and glycerin. As long as the absorption spectra of all pure forms and sufficient mixture absorption spectra of good quality are provided to the MLP regressor, it can be envisioned that the system 300 is able to tackle more complex mixture analysis tasks, such as decomposition of a quaternary or quinary mixture.

### Component Concentration Prediction Using Decomposed Pure Forms

Besides mixture absorption spectrum decomposition as afore-described, the system 300 can also obtain component concentrations of each mixture by leveraging the measured pure form and the decomposed pure form (i.e. from predicted component absorption spectra).

FIG. 37 shows a flowchart 3700 for predicting component concentrations using decomposed component absorption spectra in accordance with an embodiment.

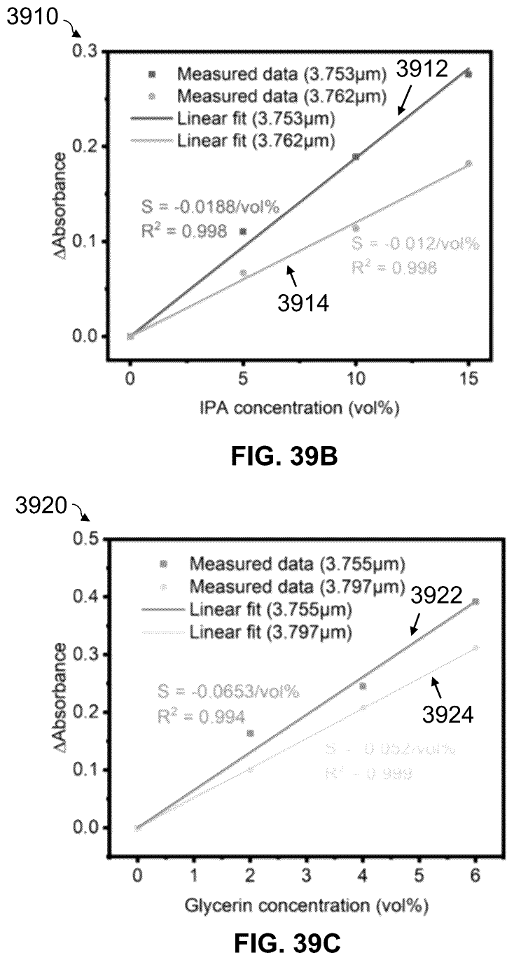

As shown in step 3702, four measured pure forms (in plots of absorbance versus wavelength) of a single component of different concentrations (in the present case, 0 vol %, 5 vol %, 10 vol % and 15 vol %) were provided. In step 3704, a linear fitting function was then applied to these four measured pure forms and the sensitivity at the same sixteen wavelength points as the predicted component absorption spectra were recorded (c.f. FIG. 34A). Examples of these sensitivity values obtained by linear fitting are shown in relation to FIGS. 39A to 39C below. The R-square values at these sixteen wavelength points were then sorted in order from largest to smallest and eight wavelength points were picked for the following calculation.

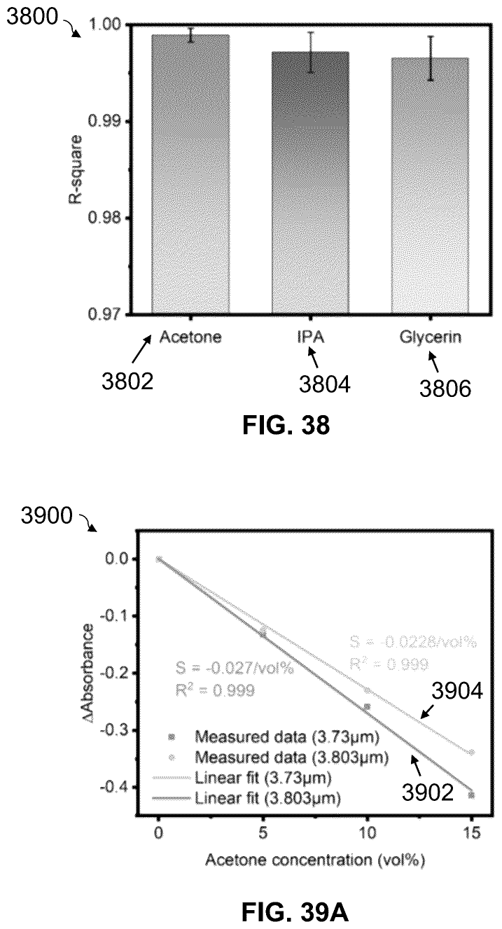

Description in relation to the R-square values for these eight selected wavelength points are shown in relation to FIGS. 38 and 39A to 39C below.

FIG. 38 shows a graph 3800 of mean R-square values calculated using measured absorption spectra of acetone 3802, IPA 3804 and glycerin 3806 at the selected eight wavelengths in accordance with an embodiment. The standard deviations are shown as error bars in the graph 3800. As shown in the graph 3800, all the mean R-square values are higher than 0.995, denoting a good linearity of the measured absorption spectrum data.

FIGS. 39A, 39B, 39C show graphs 3900, 3910, 3920 of absorbance difference (Δ Absorbance) between water and an analyte concentration for different wavelengths using measured absorption spectra in accordance with embodiments.

The absorbance difference is given in Equation 6 as:

Δ Absorbance=−(α_{analyte}−α_{water})ΓLC_{analyte}×log₁₀e=log(I_{analyte}/I_{water}) (6)

FIG. 39A shows a graph 3900 of absorbance difference (Δ Absorbance) versus acetone concentration, where a plot 3902 shows a linear fit for measured data at a laser output wavelength of 3.73 μm and a plot 3904 shows a linear fit for measured data at a laser output wavelength of 3.803 μm. FIG. 39B shows a graph 3910 of absorbance difference (Δ Absorbance) versus IPA concentration, where a plot 3912 shows a linear fit for measured data at a laser output wavelength of 3.753 μm and a plot 3914 shows a linear fit for measured data at a laser output wavelength of 3.762 μm. FIG. 39C shows a graph 3920 of absorbance difference (Δ Absorbance) versus glycerin concentration, where a plot 3922 shows a linear fit for measured data at a laser output wavelength of 3.755 μm and a plot 3924 shows a linear fit for measured data at a laser output wavelength of 3.797 μm. The sensitivity values are provided by the slopes of these linear fittings, and are different at different wavelengths due to the wavelength-dependent absorbance of the analyte. As shown by these graphs 3900, 3910, 3920, the R² values are 0.994 and above.

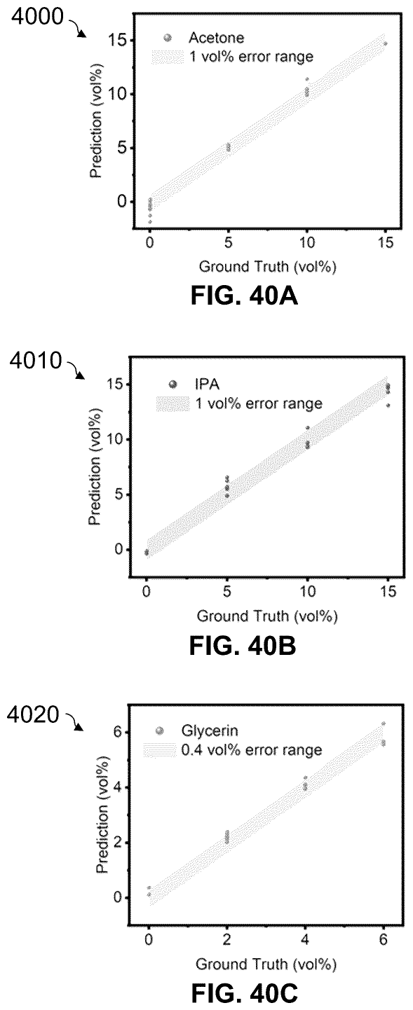

Referring back to the flowchart 3700 of FIG. 37, with the spectrum values from the predicted spectrum considered in step 3706 and the sensitivity values at eight selected wavelength points calculated from the measured pure forms in step 3708, the eight concentration values corresponding to the eight spectrum values at the eight selected wavelengths of the predicted spectrum can be obtained in step 3710. After averaging these eight corresponding concentration values in step 3712, the predicted component concentration (i.e., the average value of these eight corresponding concentration values) matching with the predicted absorption spectrum can be obtained. The predicted concentrations of 16×3 predicted absorption spectra based on sixteen mixture absorption spectra in the test dataset are shown in relation to FIGS. 40A to 40C.

FIGS. 40A, 40B, 40C show graphs 4000, 4010, 4020 of predicated analyte concentration for different expected analyte concentrations (i.e., ground truth) as determined using the MLP regressor in accordance with an embodiment.

FIG. 40A shows a graph 4000 of predicted acetone concentration versus the expected acetone concentration, FIG. 40B shows a graph 4010 of predicted IPA concentration versus the expected IPA concentration and FIG. 40C shows a graph 4020 of predicted glycerin concentration versus the expected glycerin concentration.

As shown in the graphs 4000, 4010, a 1 vol % error range is provided for acetone and IPA concentrations of 0 vol %, 5 vol %, 10 vol % and 15 vol %. For the graph 4020, a 0.4 vol % error range is shown for glycerin concentrations of 0 vol %, 2 vol %, 4 vol % and 6 vol %. The error ranges are shown as shaded area in the graphs 4000, 4010, 4020. These graphs 4000, 4010, 4020 show the prediction error levels for these three different analytes.

Due to a small difference between the measured component absorption spectra and the decomposed component absorption spectra obtained by absorption spectrum decomposition using the MLP regressor, it can be observed from the graphs 4000, 4010, 4020 that a majority of the prediction component concentrations falls within the shaded area, indicating an accurate concentration prediction result relying on the decomposed component absorption spectra.

Except for the single component concentration predictions (i.e. a pure acetone solution, a pure IPA solution, or a pure glycerin solution), the prediction error for concentration combination from a mixture can be assessed through the equation of RMSE as shown in Equation 7 below:

$$RMSE ( C , \hat{C} ) = \sqrt{\frac{1}{3} [ {( {C}_{Ace} - {\hat{C}}_{Ace} )}^{2} + {( {C}_{IPA} - {\hat{C}}_{IPA} )}^{2} + {( {C}_{gly} - {\hat{C}}_{gly} )}^{2} ]} \qquad ( 7 )$$

where Ĉ_{Ace}, Ĉ_{IPA} and Ĉ_{gly} denote the predicted component concentration of acetone, IPA, and glycerin respectively, while C_{Ace}, C_{IPA}, C_{gly} are the corresponding true component concentrations of acetone, IPA and glycerin, respectively.

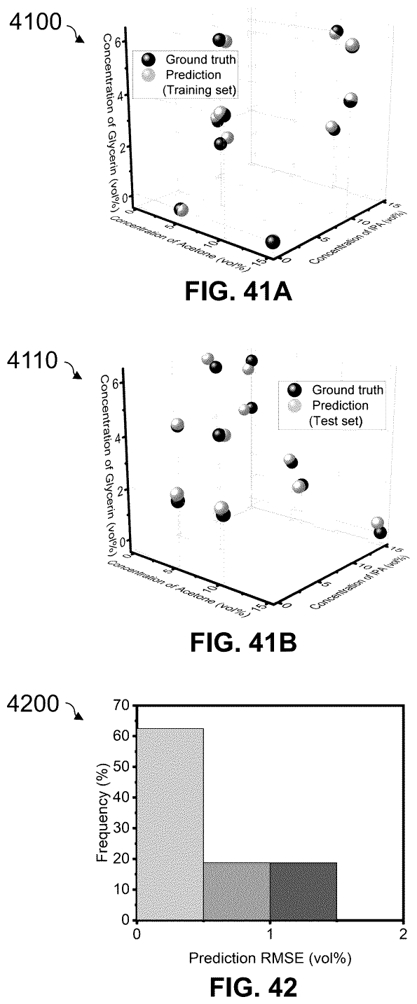

FIGS. 41A and 41B show three-dimensional (3D) visualizations 4100, 4110 of ten exemplary predicted concentration combinations and their corresponding expected concentration combinations (i.e., ground truth).

FIG. 41A shows a 3D visualization 4100 of ten predicted concentration combinations and their corresponding expected concentration combinations (i.e., ground truth) for a training data set and FIG. 41B shows a 3D visualization 4110 of ten predicted concentration combinations and their corresponding expected concentration combinations (i.e., ground truth) for a test data set. As shown in these 3D visualizations 4100, 4110, the distance between ground truth and prediction is proportional to the RMSE and kept at a low degree for all forty data points. Further, the prediction results exhibit a comparable deviation level in relation to the training dataset and the testing dataset, proving that the trained MLP regressor has strong generalization ability.

FIG. 42 shows a histogram 4200 of prediction root-mean square error (RMSE) for all sixteen concentration combinations corresponding to all sixteen mixture absorption spectra of the test data set in accordance with an embodiment.

As shown in the histogram 4200, the RMSE of all the prediction values ranges from 0.1 vol % to 1.43 vol %, with 62.5% of the prediction values having an RMSE smaller than 0.5 vol %, and more than 81% of the prediction values with an RMSE lower than 1 vol %. This again shows that the trained MLP regressor presents an accurate decomposition of the mixture spectrum, which leads to the mixture concentration predictions having low error values.

Therefore, as shown in relation to the afore-described embodiments, by designing a waveguide geometry on a silicon-on-insulator (SOI) platform, the subwavelength grating (SWG) metamaterial structure can be utilized to increase a waveguide sensor sensitivity. In this way, real-time monitoring of analytes and prolonged sensing operation can be achieved in a small footprint to fulfill the requirement of miniaturization, while keeping a balance between higher sensitivity and water absorption loss. In the present embodiments, a polydimethylsiloxane (PDMS) chamber was bonded on the chip surface to form a microfluidic channel and to confine a sensing length within 2 mm. Coupled with the application of machine learning models, two sensing functions, namely spectral recognition and decomposition of an absorption spectrum of a mixture were achieved. In the present embodiments, ternary mixtures of sixty-four different component concentrations combination comprising acetone, isopropyl alcohol (IPA), and glycerin in water solution were used. A convolution neural network (CNN) was employed to recognize the absorption spectra of mixtures with sixty-four predefined mixing ratios, and a classification accuracy of 98.88% was achieved. Additionally, absorption spectra of four glycerin solutions with different concentrations (e.g., 300 ppm) below the limit of detection (LoD, 972 ppm) were discriminated with an accuracy of 92.86%. Further, an MLP regressor was executed to analyze sixty-four mixture absorption spectra for the sixty-four predefined mixing ratios for spectrum decomposition and concentration prediction. By only using forty-eight mixture spectra comprising forty-eight concentration combinations for training, the pure forms of each component can be recovered from sixteen unknown mixture absorption spectra with an average decomposition error of around 0.027 PWP. The mixture concentration prediction based on the precise decomposed absorption spectrum of each component, namely, decomposed component absorption spectra, also brings about accurate prediction results, with 62% of the prediction values within 0.5 vol % root-mean-squared error (RMSE) and more than 81% of prediction values within 1 vol % RMSE.

The above embodiments provide a system level demonstration of a feasible and efficient solution for mixture recognition as well as quantification using waveguide sensing. This indicates good development prospects for incorporating the miniaturized optical sensors and machine learning for MIR spectrometer-on-a-chip mixture analysis in future IOT sensing system. Moreover, in embodiments where a larger bandwidth grating coupler is adopted or the SOI platform is replaced with other material platforms with a broader transparency window, such as silicon-on-nitride and germanium-on-silicon, a wider spectrum that covers more analytes with specific fingerprints can be included in the system 300. This may also be applicable to data driven mid-infrared spectrometer-on-a-chip (MIRSOC) for the data analytics of complicated and/or multiple organic components in aqueous environments for healthcare, environmental monitoring and extensive IoT sensing applications.

Further, in embodiments, a compact MIR spectrometer-on-chip with multiple analysis functions can be realized by applying diverse machine learning algorithms for analysis of sensing data from miniaturized but ultrasensitive waveguide sensor in the same photonic integrated circuit. More importantly, some important smart industry scenarios, such as wastewater plants could be built based on the extensive deployment of this type of smart sensing technique for efficient and accurate wastewater monitoring (e.g., in-situ and/or real-time monitoring applications).

The present analysis of absorption spectra using machine learning models also provide an alternative analysis method for quantification of liquid mixtures, and improves on other methods, such as (i) simultaneously using a change of both the real and imaginary parts of complex refractive index originating from the introduction of a mixture (ethanol and toluene in cyclohexane) or (ii) using a profile of a spectrum (e.g., number of absorption peaks) to differentiate analytes and determine the component concentration (ethanol in ethanol/acetonitrile compounds) by calculating the intensity ratio at two wavelengths, which primarily use a simple mixture like a binary compound without using water as solvent and only focus on one or two specific wavelength points for concentration quantification. By implementing machine learning algorithms of the present embodiments, not only the absorption spectrum of a mixture under different mixing ratios can be successfully recognized, but also the pure form or component absorption spectrum of a single component buried in the mixture spectrum can be extracted.

For the avoidance of doubt, results or data obtained for varying wavelengths are with reference to a MIR light wavelength output by a laser input for the present embodiments, unless otherwise stated.

Other alternative embodiments of the invention include: (i) using other machine learning models or algorithms, such as recurrent neural networks (RNNs) or graph neural network, for classifying an absorption spectrum to determine predicted component concentrations of a target mixture; (ii) using other machine learning models or algorithms, such as Long Short-Term Memory (LSTM), for decomposing an absorption spectrum; (iii) using other suitable sensor or waveguide sensor for measuring absorption spectrums of a mixture; (iv) having different shapes or designs for the SWG metamaterial structure other than the pillars in the described embodiments above; (v) using two SWG metamaterial structures to define a waveguide; (vi) using a wider mid-infrared input wavelength range (other than the 3.7 μm to 3.8 μm); (vii) determining a predicted component concentration of a component of a target mixture by (a) comparing a target component absorption spectrum of the component with measured absorption spectra of different concentrations of the component and (b) identifying the measured absorption spectrum that best fits the target component absorption spectrum, where the component concentration of the measured absorption spectrum that best fits the target component absorption spectrum corresponds to the predicted component concentration of the component; (viii) use of other buffers besides water, for example an organic solvent such as toluene; (ix) using a portion of the SWG metamaterial waveguide for sensing; (x) an entire length of the strip waveguide sensor comprises a SWG metamaterial structure; (xi) concentrations of a component being expressed in volume percentage (vol %), parts per million (ppm) or other suitable units; and (xii) other analytes beside acetone, IPA and glycerin and/or other buffer solution besides water as shown in the exemplary embodiments above.

Although only certain embodiments of the present invention have been described in detail, many variations are possible in accordance with the appended claims. For example, features described in relation to one embodiment may be incorporated into one or more other embodiments and vice versa. The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A system for determining predicted component concentrations of a target mixture, the system comprising:
a mid-infrared waveguide sensor configured to measure absorption spectra; and
a computer comprising a processor and a data storage storing computer program instructions operable to cause the processor to:
receive, from the mid-infrared waveguide sensor, first training absorption spectra for a plurality of training mixtures, the plurality of training mixtures each having one or more components associated with the target mixture and comprises different predetermined component concentrations;
train a first machine learning model using the first training absorption spectra to obtain a first trained machine learning model, the first trained machine learning model being adapted to classify an absorption spectrum of a mixture having one or more of the components associated with the target mixture to identify specific component concentrations of the mixture, the identified specific component concentrations being one of the different predetermined component concentrations;
receive, from the mid-infrared waveguide sensor, a target absorption spectrum of the target mixture; and
determine the predicted component concentrations of the target mixture by classifying the target absorption spectrum using the first trained machine learning model.

2. The system of claim 1, wherein the data storage of the computer further stores computer program instructions operable to cause the processor to:
receive, from the mid-infrared waveguide sensor, second training absorption spectra for the plurality of training mixtures;
train a second machine learning model using the second training absorption spectra to obtain a second trained machine learning model, the second trained machine learning model being adapted to decompose the absorption spectrum of the mixture into component absorption spectra associated with components of the mixture; and
decompose the target absorption spectrum into target component absorption spectra using the second trained machine learning model, each of the target component absorption spectra being associated with a corresponding component of the target mixture and comprises a predetermined number of data points across measured wavelengths of the target absorption spectrum.

3. The system of claim 2, wherein the data storage of the computer further stores computer program instructions operable to cause the processor to:
receive, from the mid-infrared waveguide sensor, measured absorption spectra of each of the components of the target mixture, the measured absorption spectra of each of the components include a series of measured absorption spectra of varying concentrations of a respective component;
apply linear fitting to the measured absorption spectra of each of the components to determine predetermined wavelengths of the measured absorption spectra for comparison; and
compare each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths.

4. The system of claim 3, wherein the predicted component concentration for each of the components of the target mixture includes a plurality of predicted component concentrations, each of the plurality of the predicted component concentrations being associated with a corresponding one of the predetermined wavelengths, the data storage of the computer further stores computer program instructions operable to cause the processor to:
average the plurality of predicted component concentrations to obtain an average predicted component concentration for each of the components of the target mixture.

5. The system of claim 2, wherein the second machine learning model includes a multi-layer perceptron (MLP) regressor model.

6. The system of claim 1, wherein the first machine learning model includes a convolutional neural network (CNN).

7. The system of claim 1, wherein the mid-infrared waveguide sensor comprises a subwavelength grating metamaterial waveguide formed on a substrate.

8. The system of claim 7, wherein the subwavelength grating metamaterial waveguide comprises a periodic arrangement of pillars and a period of the periodic arrangement is less than or equal to 800 nm.

9. The system of claim 7, wherein an effective index of a propagation mode of the mid-infrared waveguide sensor is higher than a refractive index of the substrate.

10. The system of claim 1, wherein the target absorption spectrum is measured in a mid-infrared wavelength range of 3.7 μm to 3.8 μm.

11. A system for determining predicted component concentrations of a target mixture, the system comprising:
a mid-infrared waveguide sensor configured to measure absorption spectra; and
a computer comprising a processor and a data storage storing computer program instructions operable to cause the processor to:
receive, from the mid-infrared waveguide sensor, training absorption spectra for a plurality of training mixtures, the plurality of training mixtures each having one or more components associated with the target mixture and comprises different predetermined component concentrations;
train a machine learning model using the training absorption spectra to obtain a trained machine learning model, the trained machine learning model being adapted to decompose an absorption spectrum of a mixture into component absorption spectra associated with components of the mixture, wherein the components of the mixture include one or more components of the target mixture;
receive, from the mid-infrared waveguide sensor, a target absorption spectrum of the target mixture;
decompose the target absorption spectrum into target component absorption spectra using the trained machine learning model, each of the target component absorption spectra being associated with a corresponding component of the target mixture and comprises a predetermined number of data points across measured wavelengths of the target absorption spectrum;
receive, from the mid-infrared waveguide sensor, measured absorption spectra of each of the components of the target mixture, the measured absorption spectra include a series of measured absorption spectra of varying concentrations of a respective component;
apply linear fitting to the measured absorption spectra of each of the components of the target mixture to determine predetermined wavelengths of the measured absorption spectra for comparison; and
compare each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths.

12. The system of claim 11, wherein the predicted component concentration for each of the components of the target mixture includes a plurality of predicted component concentrations, each of the plurality of the predicted component concentrations being associated with a corresponding one of the predetermined wavelengths, the data storage of the computer further stores computer program instructions operable to cause the processor to:
average the plurality of predicted component concentrations to obtain an average predicted component concentration for each of the components of the target mixture.

13. A computer-implemented method for determining predicted component concentrations of a target mixture, the method comprising:
receiving, from a mid-infrared waveguide sensor, first training absorption spectra for a plurality of training mixtures, the plurality of training mixtures each having one or more components associated with the target mixture and comprises different component concentrations;
training a first machine learning model using the first training absorption spectra to obtain a first trained machine learning model, the first trained machine learning model being adapted to classify an absorption spectrum of a mixture having one or more of the components associated with the target mixture to identify specific component concentrations of the mixture, the identified specific component concentrations being one of the different predetermined component concentrations;
receiving, from the mid-infrared waveguide sensor, a target absorption spectrum of the target mixture; and
determining the predicted component concentrations of the target mixture by classifying the target absorption spectrum using the first trained machine learning model.

14. The computer-implemented method of claim 13, further comprising:
receiving, from the mid-infrared waveguide sensor, second training absorption spectra for the plurality of training mixtures;
training a second machine learning model using the second training absorption spectra to obtain a second trained machine learning model, the second trained machine learning model being adapted to decompose the absorption spectrum of the mixture into component absorption spectra of the components of the mixture; and
decomposing the target absorption spectrum into target component absorption spectra using the second trained machine learning model, each of the target component absorption spectra being associated with a corresponding component of the target mixture and comprises a predetermined number of data points across measured wavelengths of the target absorption spectrum.

15. The computer-implemented method of claim 14, further comprising:
receiving, from the mid-infrared waveguide sensor, measured absorption spectra of each of the components of the target mixture, the measured absorption spectra of each of the components include a series of measured absorption spectra of varying concentrations of a respective component;
applying linear fitting to the measured absorption spectra of each of the components to determine predetermined wavelengths of the measured absorption spectra for comparison; and
comparing each of the target component absorption spectra of the target mixture with the measured absorption spectra of a corresponding component at the predetermined wavelengths to determine a predicted component concentration for each of the components of the target mixture, wherein the predicted component concentration is associated with a concentration of the corresponding component having the measured absorption spectrum that best fits the target component absorption spectrum of the corresponding component of the target mixture at the predetermined wavelengths.

16. The computer-implemented method of claim 15, wherein the predicted component concentration for each of the components of the target mixture includes a plurality of predicted component concentrations, each of the plurality of the predicted component concentrations being associated with a corresponding one of the predetermined wavelengths, the computer-implemented method further comprising:
averaging the plurality of predicted component concentrations to obtain an average predicted component concentration for each of the components of the target mixture.

17. The computer-implemented method of claim 14, wherein the second machine learning model includes a multi-layer perceptron (MLP) regressor model.

18. The computer-implemented method of claim 13, further comprising: normalizing the first training absorption spectra and the target absorption spectrum with a buffer absorption spectrum of a buffer solution, the buffer solution being the buffer used in the plurality of training mixtures and the target mixture.

19. The computer-implemented method of claim 13, wherein the first machine learning model includes a convolutional neural network (CNN).

20. The computer-implemented method of claim 13, wherein the mid-infrared waveguide sensor comprises a subwavelength grating metamaterial waveguide formed on a substrate.
